(19) United States
(12) Patent Application Publication
(10) Pub. No.: US 2009/0136697 A1
(43) Pub. Date: May 28, 2009

(54) ANNULAR METAL CORD, ENDLESS METAL BELT, AND METHOD OF PRODUCING ANNULAR METAL CORD

(75) Inventors: Yuichi Sano, Utsunomiya-shi (JP); Hitoshi Wakahara, Utsunomiya-shi (JP); Kenichi Okamoto, Itami-shi (JP); Hiroshi Sasabe, Utsunomiya-shi (JP)

Correspondence Address: OSHA LIANG L.L.P., TWO HOUSTON CENTER, 909 FANNIN, SUITE 3500, HOUSTON, TX, 77010, US

(73) Assignees: SUMITOMO (SEI) STEEL WIRE CORP., Itami-Shi, Hyogo (JP); SUMITOMO ELECTRIC TOCHIGI CO., LTD., Utsunomiya-Shi, Tochigi (JP)

(21) Appl. No.: 12/160,202

(22) PCT Filed: Sep. 14, 2007
(86) PCT No.: PCT/JP2007/067983

§ 371 Date: Jul. 7, 2008

(30) Foreign Application Priority Data
Oct. 26, 2006 (JP) 2006-291728
Feb. 28, 2007 (JP) 2007-050573
Jun. 4, 2007 (JP) 2007-148298

(51) Int. Cl. B32B 1/08; B05D 1/32

(52) U.S. Cl. 428/36.3; 427/282

(57) ABSTRACT

An annular metal cord includes an annular core portion formed in an annular shape, and an outer layer portion spirally wound around the annular core portion while running over an annular circumference thereof plural times and covering an outer peripheral surface of the annular core portion. Each of the annular core portion and the outer layer portion are formed by a strand material which is formed by intertwisting a plurality of metal filaments. At least part of the outer layer portion is covered with an outer layer sheath made of a coating material having elasticity.

### TECHNICAL FIELD

The present invention relates to an annular metal cord, an endless metal belt, and a method of producing the annular metal cord.

### BACKGROUND ART

Hitherto, as a type of endless metal belt, there has been known, as is described, for example, in Patent Document 1, an endless metal belt having a rectangular cross section which is produced by bending a rolled strap material, welding both ends thereof together into a cylindrical shape, and cutting it at a predetermined width.

In addition, as is described, for example, in Patent Document 2, there is known an endless belt in which a metal cord is used as a core material. The metal cord, which constitutes the core material, includes at least one filament serving as a central core and a plurality of filaments which are wound around the central core.

Patent Document 1: Japanese Unexamined Patent Application Publication No. 2003-236610

Patent Document 2: Japanese Unexamined Patent Application Publication No. 4-307146

### DISCLOSURE OF INVENTION

### Problems to be Solved by the Invention

Since the endless metal belt described in Patent Document 1 has the rectangular cross section, the endless metal belt is susceptible to torsion and is apt to break. Also, when the metal cord described in Patent Document 2 is applied to an endless metal belt, both end portions of the metal cord need to be joined together to form an annular shape. As a practically conceivable method for joining together both the end portions of the metal cord, there are a method of joining together both the end portions of the metal cord in an abutted state, and a method of joining together both end portions of each of filaments which constitute the metal cord. With the method of joining together both the end portions of the metal cord in an abutted state, since a resulting annular metal cord is joined at a single concentrated location in the circumferential direction, a complete break of the annular metal cord is liable to occur. On the other hand, with the method of joining together both the end portions of each of the filaments, since the end portions of the filament have to be joined together after they are untwisted and then the end portions of the filament have to be re-twisted after they have been joined together, the twisted state differs between the joined portion and the other portion of a resulting annular metal cord, thus causing a fear that the mechanical strength of the joined portion is decreased. As a result, the metal cord is apt to break. In addition, with the method of joining together both the end portions of each of the filaments, the joining process is complex and troublesome, which causes a difficulty in producing the annular metal cord.

Accordingly, an object of the present invention is to provide an annular metal cord and an endless metal belt, which are hard to break and easy to produce, as well as a method of producing the annular metal cord.

### Means for Solving the Problems

An annular metal cord according to the present invention, which is capable of solving the above-described problems, comprises an annular core portion formed in an annular shape, and an outer layer portion spirally wound around the annular core portion while running over an annular circumference thereof plural times and covering an outer peripheral surface of the annular core portion, each of the annular core portion and the outer layer portion being formed by a strand material which is formed by intertwisting a plurality of metal filaments, wherein at least part of the outer layer portion is covered with an outer layer sheath made of a coating material having elasticity.

Thus, since at least part of the outer layer portion is covered with the outer layer sheath made of the coating material having elasticity, the annular metal cord can be made superior in break strength and fatigue resistance, as well as sturdy. Further, the presence of the outer layer sheath can eliminate the problem that the strand materials are loosened and separated from each other. In addition, since the outer layer sheath serves as a cushioning material, the following advantage is obtained. For example, even at a location where the annular metal cord contacts, e.g., a pulley around which it is curved at a small radius of curvature, the presence of the outer layer sheath increases frictional resistance between the annular metal cord and a counterpart with which the former contacts. It is therefore possible to suppress a slippage, to minimize wear, and to obtain satisfactory power transmission efficiency.

Preferably, part of the outer layer portion including at least a joined portion between a winding start end and a winding terminal end of the outer layer portion is covered, including the vicinity of the joined portion, with the outer layer sheath. With that feature, the joined portion between the winding start end and the winding terminal end of the outer layer portion can be firmly reinforced. Further, such covering can eliminate the problem that metal filaments constituting the strand material are loosened and unwound.

Preferably, an unsheathed portion is formed in an annular outer-half peripheral surface of the outer layer sheath in at least one location. With that feature, a lubricant can be smoothly permeated into the interior through the unsheathed portion, thus suppressing a reduction of strength due to fretting wears between the annular core portion and the outer layer portion, between adjacent parts of the strand material constituting the outer layer portion, and between metal filaments constituting each of the strand materials, as well as shortening of the useful life due to fatigue.

Preferably, an unsheathed portion is annularly entirely formed in an annular outer-half peripheral surface of the outer layer sheath in at least one location in a circumferential direction of a cross section thereof. With that feature, since the unsheathed portion is annularly entirely formed, a lubricant can be smoothly permeated into the interior through the unsheathed portion, and evenness in rigidity of the annular metal cord can be improved over its entire annular circumference while suppressing a reduction of strength due to fretting wear between the metal filaments, as well as shortening of the useful life due to fatigue.

Preferably, an annular outer-half peripheral surface of the outer layer sheath is annularly entirely formed as an unsheathed portion. In other words, the outer layer sheath is provided only on an annular inner-half peripheral surface. As a result, the strand material can be held in an integral state while minimizing an increase of rigidity caused with the provision of the outer layer sheath.

Preferably, an unsheathed portion is formed in an annular inner-half peripheral surface of the outer layer sheath in at least one location. With that feature, a lubricant can be smoothly permeated into the interior through the unsheathed portion formed in the annular inner-half peripheral surface.

Preferably, a sheathed portion coated with the outer layer sheath and an unsheathed portion not coated with the outer layer sheath are alternately formed over an entire circumferential surface and an entire length of the outer layer portion. With that feature, a lubricant can be smoothly permeated into the interior through an exposed area provided by the unsheathed portion, thus suppressing a reduction of strength due to the friction between the annular core portion and the outer layer portion, between adjacent parts of the strand material constituting the outer layer portion, and between the metal filaments constituting each of the strand materials, as well as shortening of the useful life due to fatigue.

Preferably, the sheathed portion is formed to be longer than the unsheathed portion. Thus, those portions can be formed such that the unsheathed portion has the least necessary length for permeation of a lubricant into the interior and the sheathed portion has a length as long as possible. Therefore, the reinforcing effect can be increased and the useful life can be prolonged.

Preferably, the unsheathed portion is formed in at least one location in an annular direction of the outer layer portion. With that feature, a lubricant can be permeated into the interior through the unsheathed portion formed in at least one location in the annular direction of the outer layer portion. Further, since an area of the unsheathed portion is minimized, the reinforcing effect with the outer layer sheath can be increased and the useful life can be prolonged.

Preferably, an adhesive coated portion in which a coating adhesive is applied and hardened and an adhesive uncoated portion in which the coating adhesive is not applied are alternately formed on an outer peripheral surface of the annular core portion. With that feature, the annular core portion can be reinforced in itself with the provision of the adhesive coated portion and the strength of the annular metal cord can be increased. Also, the provision of the adhesive uncoated portion enables a lubricant to be smoothly permeated into the interior of the annular core portion through the adhesive uncoated portion, thus suppressing a reduction of strength due to the friction between the metal filaments constituting the strand material which constitutes the annular core portion, as well as shortening of the useful life due to fatigue.

Preferably, the unsheathed portion in which the outer layer portion is not covered with the outer layer sheath and the adhesive uncoated portion in which the annular core portion is not covered with the coating adhesive are arranged at positions differing from each other in an annular direction. Thus, since the position of the unsheathed portion and the position of the adhesive uncoated portion are shifted from each other in the annular direction, a reduction of the reinforcing effect caused by the provision of both the unsheathed portion and the adhesive uncoated portion can be held at minimum.

Preferably, at least one of the coating adhesive and the outer layer sheath has hardness (Japanese Industrial Standards (JIS)-A) of 22-60 and elongation of 110-500% as physical properties after hardening thereof. By using the coating adhesive and the outer layer sheath at least one of which has hardness (JIS-A) of 22-60 and elongation of 110-500%, a high reinforcing effect can be obtained while ensuring flexibility and appropriate elongation.

Preferably, the outer layer sheath is made of rubber. Thus, by forming the outer layer sheath in a predetermined location by using rubber, the annular metal cord can be easily reinforced. Further, since the outer layer sheath made of rubber increases frictional resistance between the annular metal cord and a counterpart with which the former contacts, the annular metal cord can be suitably used as a satisfactory power transmission belt.

Preferably, the rubber forming the outer layer sheath is bonded to the outer layer portion by a metal-rubber adhesive for bonding metal and rubber to each other. With that feature, the rubber and the strand material constituting the outer layer portion can be reliably fixed to each other and the reinforcing effect can be increased.

Preferably, the rubber forming the outer layer sheath is vulcanized at a vulcanization pressure of 8 MPa or lower. With that feature, penetration of the rubber into the interior of the annular metal cord can be prevented while allowing satisfactory permeation of a lubricant, thus suppressing a reduction of strength due to fretting wears between the annular core portion and the outer layer portion, between adjacent parts of the strand material constituting the outer layer portion, and between the metal filaments constituting each of the strand materials, as well as shortening of the useful life due to fatigue.

However, when the annular metal cord is employed under an environment in which no lubricant is used, it is rather preferable that the rubber be vulcanized at such a vulcanization pressure as allowing the rubber to positively penetrate into the interior of the annular metal cord.

An endless metal belt according to the present invention, which is capable of solving the above-described problems, is featured in including the annular metal cord according to the present invention. By using the above-described annular metal cord, an endless metal belt can be obtained which has superior break strength and fatigue resistance and is easy to produce.

A method of producing the annular metal cord according to the present invention, which is capable of solving the above-described problems, comprises the steps of pasting a masking tape to part of the annular metal cord where the outer layer sheath is not to be formed, applying a coating adhesive over an outer peripheral surface of the annular metal cord, and removing the masking tape after the applied coating adhesive has hardened.

Thus, by pasting a masking tape to part of the annular metal cord where the outer layer sheath is not to be formed, applying a coating adhesive over an outer peripheral surface of the annular metal cord, and removing the masking tape after the applied coating adhesive has hardened, the annular metal cord can be easily produced which is covered with the outer layer sheath made of the coating adhesive, is sturdy, is free from the problem of loosening and unwinding of the strand material, and which allows a lubricant to smoothly permeate into the interior.

Further, a method of producing the annular metal cord according to the present invention, which is capable of solving the above-described problems, comprises the steps of pasting a masking tape to part of the annular metal cord where the outer layer sheath is not to be formed, pasting raw rubber over an outer peripheral surface of the annular metal cord, and removing the masking tape after carrying out a pressurization and vulcanization process.

Thus, by pasting a masking tape to part of the annular metal cord where the outer layer sheath is not to be formed, pasting raw rubber over an outer peripheral surface of the annular metal cord, and removing the masking tape after carrying out a pressurization and vulcanization process, the annular metal cord can be easily produced which is covered with the outer layer sheath made of the rubber, is sturdy, is free from the problem of loosening and unwinding of the strand material, and which allows a lubricant to smoothly permeate into the interior.

### ADVANTAGES

According to the present invention, the annular metal cord and the endless metal belt can be provided which have superior break strength and fatigue resistance and are easy to produce, and the method of producing the annular metal cord can also be provided. Consequently, when the annular metal cord and the endless metal belt of the present invention are used in an industrial machine, the industrial machine can be made to have superior durability.

### BRIEF DESCRIPTION OF DRAWINGS

FIG. 1 is a perspective view of an annular metal cord according to a first embodiment of the present invention.

FIG. 2 is a perspective view of the annular metal cord according to the first embodiment in a state before an outer layer sheath is formed.

FIG. 3 is a perspective view showing the annular metal cord, radially sectioned, according to the first embodiment.

FIG. 4 is a perspective view showing a state where a second strand material is wound around an annular core portion while running over its annular circumference once, which is included in the annular metal cord according to the first embodiment.

FIG. 5(a) is a radial sectional view showing the annular metal cord according to the first embodiment, and FIG. 5(b) is a side view of the annular metal cord.

FIG. 6 is an enlarged perspective view showing part of the annular metal cord according to the first embodiment.

FIG. 7 is a perspective view showing one example of a production apparatus for producing the annular metal cord.

FIG. 8 is a front view of the apparatus, shown in FIG. 7, showing, by solid lines, a state where a reel is positioned outside a loop of the annular core portion at one end of a cycle of swing motions of the annular core portion and, by chain lines, a state where the reel is positioned inside the loop of the annular core portion at the other end of the cycle of swing motions of the annular core portion.

FIG. 9 is a front view of the apparatus, shown in FIG. 7, showing contrary to FIG. 8, by solid lines, a state where the reel is positioned inside the loop of the annular core portion at one end of the cycle of swing motions of the annular core portion and, by chain lines, a state where the reel is positioned outside the loop of the annular core portion at the other end of the cycle of swing motions of the annular core portion.

FIG. 10 is a front view of the annular core portion constituting the annular metal cord C1.

FIG. 11 is a conceptual view showing, as viewed from above, a state of the reel being moved when the annular metal cord is produced.

FIG. 12(a)-12(e) are sectional views showing other examples of an unsheathed portion.

FIG. 13 is a perspective view showing an endless metal belt in a state during use.

FIG. 14 is a perspective view of an annular metal cord according to a second embodiment of the present invention.

FIG. 15 is a perspective view of the annular metal cord according to the second embodiment in a state before an outer layer sheath is formed.

FIG. 16 is a perspective view showing the annular metal cord, radially sectioned, according to the second embodiment.

FIG. 17 is a perspective view showing a state where a strand material is wound around an annular core portion while running over its annular circumference once, which is included in the annular metal cord according to the second embodiment.

FIG. 18(a) is a radial sectional view showing the annular metal cord according to the second embodiment, and FIG. 18(b) is a side view of the annular metal cord.

FIG. 19 is an enlarged perspective view showing part of the annular metal cord according to the second embodiment.

FIG. 20 is a conceptual view showing a step of forming the annular core portion of the annular metal cord according to the second embodiment.

FIG. 21 is a perspective view of annular metal cords according to third and fourth embodiments of the present invention.

### REFERENCE NUMERALS

1 . . . first strand material, 2 . . . second strand material, 3,13 . . . annular core portion, 4,14 . . . outer layer portion, 5,6,15 . . . metal filament, 10 . . . outer layer sheath (sheathed portion), 10A . . . unsheathed portion, 11 . . . strand material, B1 . . . endless metal belt, and C1,C2,C3,C4 . . . annular metal cord.

### BEST MODES FOR CARRYING OUT THE INVENTION

Preferred embodiments of the present invention will be described in detail below with reference to the accompanying drawings. It is to be noted that identical elements or elements having identical functions are denoted by the same reference numerals in the following description, and a duplicate description of those elements is omitted.

### First Embodiment

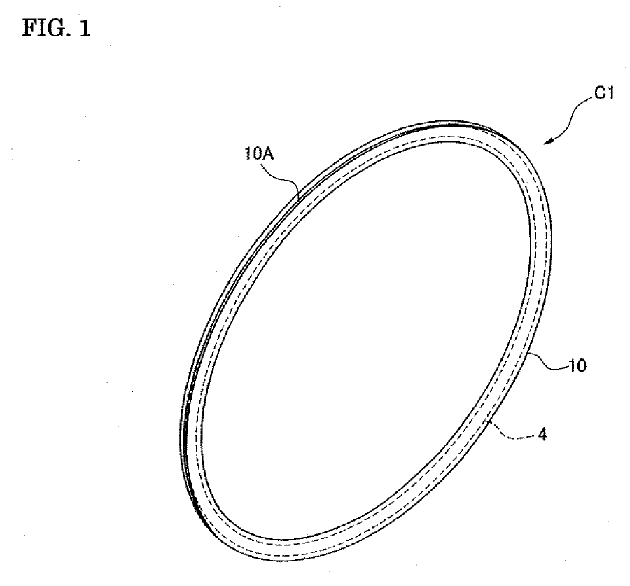

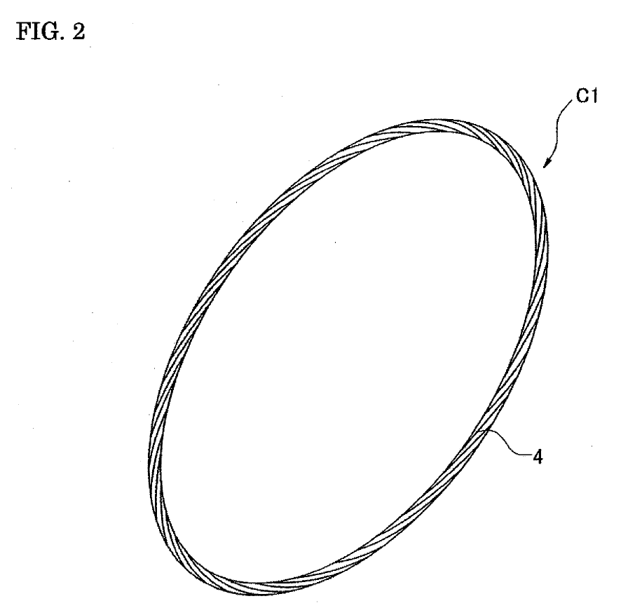

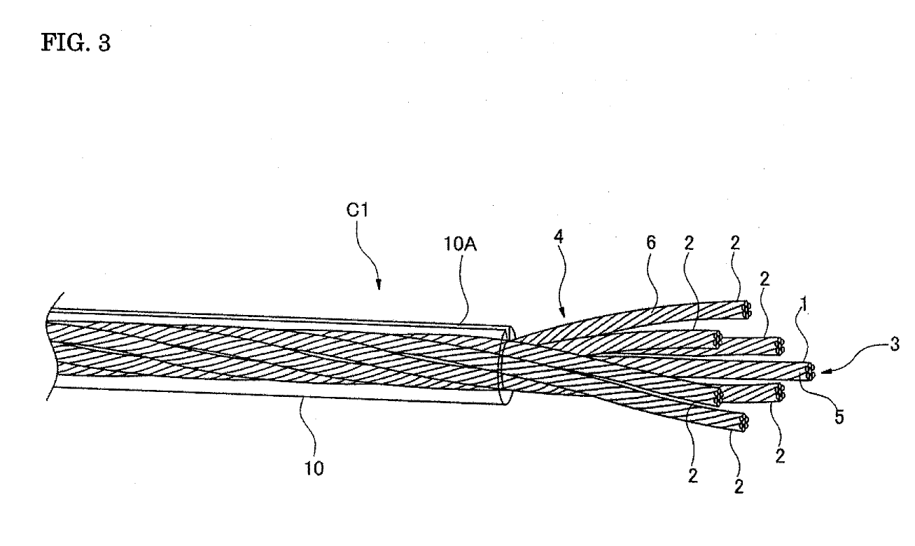

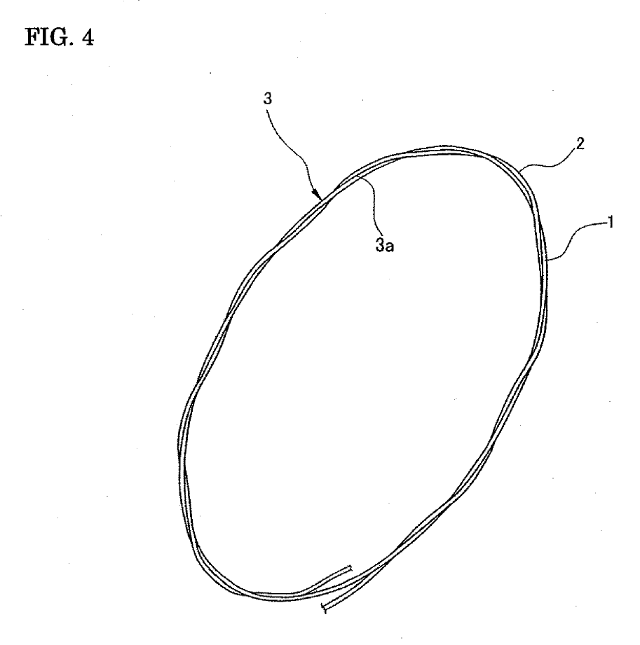

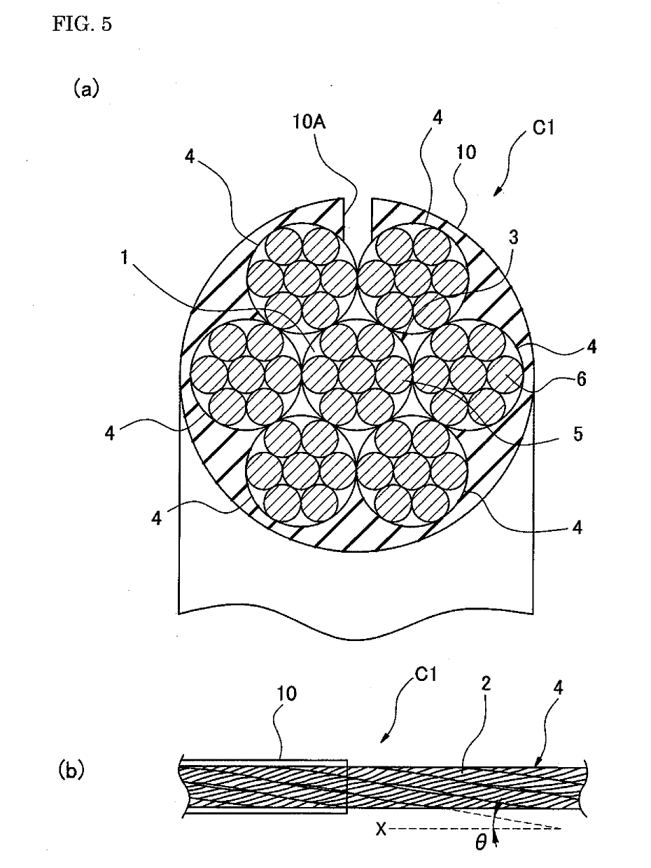

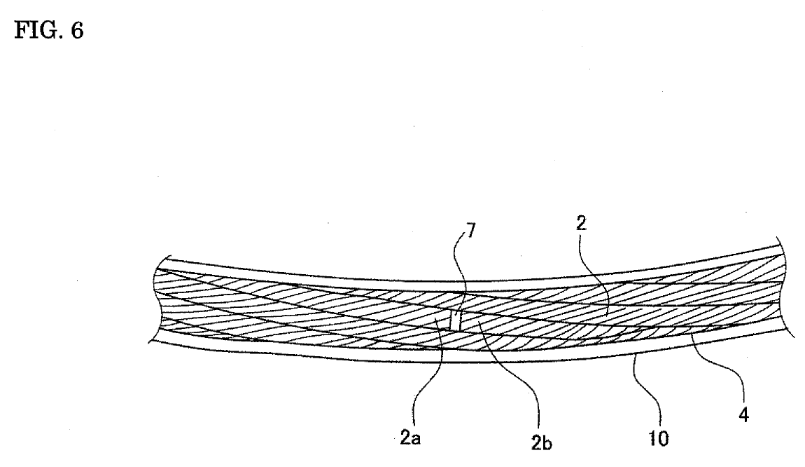

An annular metal cord according to a first embodiment will be described with reference to the drawings. FIG. 1 is a perspective view of the annular metal cord according to the first embodiment of the present invention, FIG. 2 is a perspective view of the annular metal cord according to the first embodiment in a state before an outer layer sheath is formed, FIG. 3 is a perspective view showing the annular metal cord, radially sectioned, according to the first embodiment, and FIG. 4 is a perspective view showing a state where a second strand material is wound around an annular core portion while running over its annular circumference once, which is included in the annular metal cord according to the first embodiment. FIG. 5(a) is a radial sectional view showing the annular metal cord according to the first embodiment, and FIG. 5(b) is a side view of the annular metal cord according to the first embodiment. FIG. 6 is an enlarged perspective view showing part of the annular metal cord according to the first embodiment.

As shown in FIG. 1, an annular metal cord C1 is covered at its outer peripheral side with an outer layer sheath 10. The outer layer sheath 10 is formed by applying a coating adhesive, which is a coating material having elasticity, and hardening the applied adhesive.

The annular metal cord C1 has an unsheathed portion 10A in which the outer layer sheath 10 is not coated. The unsheathed portion 10A is formed in the shape of a slit which is annularly extended over an entire circumference of the outer layer sheath 10 in its annular outer-half peripheral surface.

The coating adhesive forming the outer layer sheath 10 has superior heat resistance and oil resistance. For example, a silicone rubber-based adhesive having elasticity is used. As physical properties after hardening, the coating adhesive has hardness (JIS-A) of 22-60 and elongation of 110-500%. ThreeBond 1222B (made by ThreeBond Co., Ltd.), which is one product of a silicone adhesive sealant, can be used, by way of example, as the coating adhesive for forming the outer layer sheath 10. That product is suitable for the outer layer sheath 10 because it is a sealant having not only heat resistance, cold resistance, weather resistance, durability, and wear resistance, but also quick-drying and -hardening properties. Incidentally, ThreeBond 1222B has hardness (JIS-A) of 27 and elongation of 450%.

As shown in FIGS. 2 and 3, the annular metal cord C1 includes an annular core portion 3 and an outer layer portion 4 covering an outer peripheral surface of the annular core portion 3.

The annular core portion 3 is formed by joining together both ends of a first strand material 1. Therefore, as shown in FIG. 4, the annular core portion 3 has a joined portion 3a. In the first embodiment, both the ends of the first strand material 1 are joined together by welding. By joining together both the ends of the first strand material by welding, the diameter of the joined portion is less apt to increase in comparison with the case of Joining together both the ends by another method. Therefore, the annular core portion 3 can be obtained in such a state as allowing a second stand material 2 to be smoothly wound around the joined portion as well.

As shown in FIG. 5(a), the first strand material 1 is formed by intertwisting a plurality of first metal filaments 5. In the first embodiment, as illustrated in FIG. 3, the first strand material 1 is constituted such that one of the first metal filaments 5 is situated at a center and other six first strand filaments 5 are wound in S-twist around an outer peripheral surface of the first metal filament 5 at the center. Thus, since the first strand material 1 is in the geometrically stable form made up of seven intertwisted filaments, it is sturdy and is hard to break.

Each of the first metal filaments 5 is made of alloy steel and contains, as material composition, C: 0.08-0.27 mass %, Si: 0.30-2.00 mass %, Mn: 0.50-2.00 mass %, and Cr: 0.20-2.00 mass %. Further, the first metal filament 5 contains at least one of Mo: 0.01-1.00 mass %, Ni: 0.10-2.00 mass %, Co: 0.10-2.00 mass %, and W: 0.01-1.00 mass %. In addition, the first metal filament 5 contains at least one of Al, Nb, Ti and V in the range of 0.001-0.10 mass %, and the balance comprises Fe and inevitably mixed impurities. Since the first metal filaments 5 each made of the above-described material composition are used for the first strand material 1, the first strand material 1 has satisfactory weldability and superior heat resistance. Note that the material composition of the first metal filament 5 is not limited to the above-described one.

The first metal filament 5 has a diameter in the range of 0.06-0.40 mm. Since the diameter of the first metal filament 5 is larger than 0.06 mm, the first strand material 1 can be made to have appropriate rigidity and improved fatigue resistance. Also, since the first strand material 1 forming the annular core portion 3 is positioned at the center of the annular metal cord C1 in its cross section, the first strand material 1 is subjected to smaller stresses than those imposed on the second strand material 2 in a state where the annular metal cord C1 is bent. Therefore, the diameter of the first metal filament 5 can be increased within the range of 0.06-0.40 mm to be larger than that of a second metal filament 6 for increasing rigidity of the first metal filament 5. In addition, since the diameter of the first metal filament 5 is smaller than 0.40 mm, the rigidity of the first strand material 1 can be kept from increasing excessively and the annular metal cord C1 can be made less apt to cause a fatigue break due to repeated stresses.

The outer layer portion 4 is formed by winding the second strand material 2 around the annular core portion 3 serving as an axial core. As shown in FIG. 5(a), the second strand material 2 is formed by intertwisting a plurality of second metal filaments 6.

Each of the second metal filaments 6 is made of high-carbon steel containing 0.60 mass % or more of C. By selecting a material containing 0.60 mass % or more of C, the second metal filament 6 can be obtained as a steel wire having more superior break strength. The second metal filament 6 may be made of the same material as that of the first metal filament 5. However, the second metal filament 6 not subjected to the joining by welding is more preferably made of the material containing 0.60 mass % or more of C. Note that the material composition of the second metal filament 6 is not limited to the above-described one.

The second metal filament 6 has a diameter in the range of 0.06-0.30 mm. By so setting, the second strand material 2 can be made to have appropriate rigidity and improved fatigue resistance. Therefore, the second strand material 2 can be easily wound around the annular core portion 3 and loosening of the wound second strand material 2 is less apt to occur. The diameter of the second metal filament 6 is more preferably in the range of 0.06-0.22 mm.

In the first embodiment, as shown in FIG. 3, the second strand material 2 is formed by winding six second strand filaments 6 in S-twist around an outer peripheral surface of one second metal filament 6. Thus, since the second strand material 2 is in the geometrically stable form made up of seven intertwisted filaments, it is sturdy and is hard to break.

The second strand material 2 is spirally wound around the annular core portion 3 while running over its annular circumference plural times, as shown in FIGS. 3 and 4. The second strand material 2 is wound in a manner causing no torsion. By the winding with no torsion, loosing of the wound second strand material 2 can be suppressed.

In the first embodiment, the second strand material 2 is wound along the outer peripheral surface of the annular core portion 3 while running over its annular circumference six times. Since the second strand material 2 has almost the same diameter as that of the annular core portion 3 formed by the first strand material 1, the second strand material 2 is wound around the outer peripheral surface of the annular core portion 3 with substantially no gaps left. Accordingly, the outer layer portion 4 closely covers the annular core portion 3. The annular metal cord C1 has a cross section that, as shown in FIG. 5(a), six parts of the second strand material 2 are arrayed around the first strand material 1 serving as the annular core portion 3. Such a cross section is the same as that of the first strand material 1 and the second strand material 2 each of which is formed by intertwisting seven filaments. Thus, since the annular metal cord C1 has a geometrically stable structure, it has superior break strength and fatigue resistance and is durable against deformations in the radial direction.

As shown in FIG. 4, the second strand material 2 is wound in Z-twist around the outer peripheral surface of the annular core portion 3. Since the first strand material 1 and the second strand material 2 are each in itself formed by winding the filaments in S-twist, the annular metal cord C1 includes the S-twist and the Z-twist in a mixed state. Consequently, the annular metal cord C1 can be obtained which is hard to cause torsion and has less ruggedness in its external appearance.

In addition, the second strand material 2 is wound at a predetermined winding angle with respect to a center axis of the annular core portion 3. Therefore, the second strand material 2 can be wound without disorder, and the annular metal cord C1 having a substantially uniform surface state can be obtained. In the first embodiment, as shown in FIG. 5(b), a winding angle θ of the second strand material 2 with respect to the X-direction, i.e., the direction in which the center axis of the annular core portion 3 extends, is 4.5-13.8 degrees. By setting the winding angle θ to be larger than 4.5 degrees, the loosing of the wound second strand material 2 can be made less apt to occur. By setting the winding angle θ to be smaller than 13.8 degrees, the elongation of the second strand material 2 can be prevented from increasing excessively. In other words, by setting the winding angle θ of the second strand material 2 to be 4.5-13.8 degrees, the annular metal cord C1 having appropriate elongation and being easy to bend can be obtained. When the annular metal cord C1 having such properties is used, for example, in an endless metal belt of a continuously variable transmission described later, power transmission between a drive pulley and a driven pulley can be performed with high accuracy.

As shown in FIG. 6, a winding start end 2a and a winding terminal end 2b of the second strand material 2 are joined together by welding.

Further, the outer layer portion including a joined portion 7 in which the winding start end 2a and the winding terminal end 2b of the second strand material 2 are joined together is covered with the outer layer sheath 10.

Thus, the outer layer portion 4 is formed by winding the second strand material 2 around the annular core portion 3, and then joining and welding together the winding start end 2a and the winding terminal end 2b of the second strand material 2.

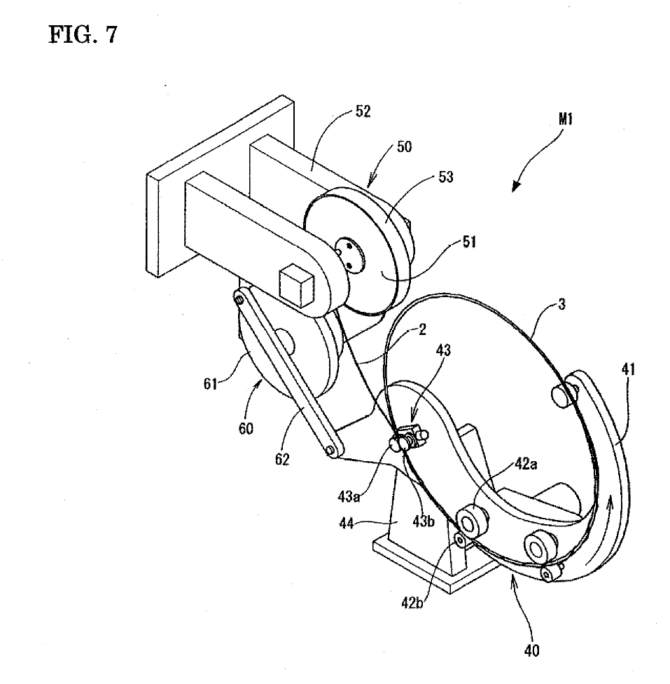

Subsequently, a method of producing the annular metal cord C1 will be described. FIG. 7 is a perspective view showing one example of a production apparatus for producing the annular metal cord C1.

An illustrated production apparatus Ml includes a driving unit 40 for rotating the annular core portion 3 in the circumferential direction, and a supply unit 50 for the second strand material 2, which supplies the second strand material 2 rolled up around a reel 51 to a winding area of the annular core portion 3.

The supply unit 50 for the second strand material 2 is fixed in a predetermined position.

The driving unit 40 is installed on an arc-shaped holding arm 41 and has two pinch rollers 42a and 42b which are coupled to a driving motor and rotate the annular core portion 3 in the circumferential direction.

The holding arm 41 includes a clamping unit 43 which is disposed on its part positioned nearer to the supply side of the second strand material 2 in a direction opposed to the rotating direction of the annular core portion 3 and which surrounds the annular core portion 3. The clamping unit 43 comprises two rollers 43a and 43b and serves to prevent a lateral shake of the annular core portion 3, to maintain stable rotation in the circumferential direction, and to properly position a winding point for the second strand material 2, thereby ensuring high winding performance. Note that, in the illustrated example, the annular core portion 3 is vertically standing and is rotated in the circumferential direction while suppressing the lateral shake.

Since the clamping unit 43 comprising the two rollers 43a and 43b is just required to have the functions of preventing a lateral shake of the annular core portion 3, surrounding the annular core portion 3 and maintaining stable rotation in the circumferential direction even with the annular metal cord having a final finish diameter, and fixedly positioning the winding point where the second strand material 2 starts to be twisted, a groove shape is not limited to particular one and it may be substantially channel- or C-like, arcuate, or V-like.

The holding arm 41 is swingably installed on a stand 44 so as to perform swing motions by a swing mechanism 60, which comprises a rotary disk 61 and a crankshaft 62, with the clamping unit 43 serving as a fulcrum.

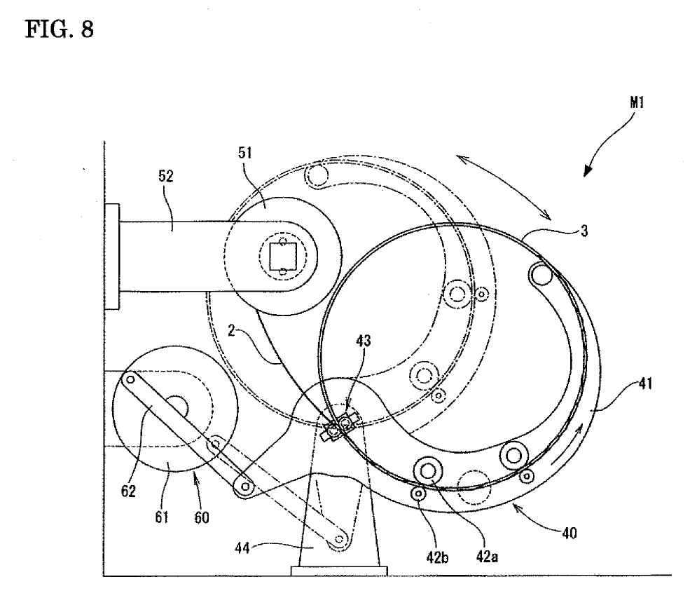

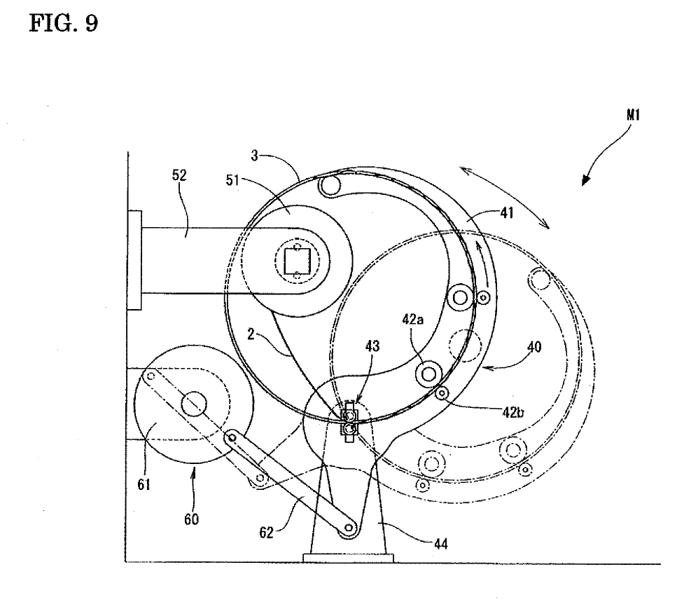

The annular core portion 3 held by the holding arm 41 swings such that the reel 51 is positioned outside a loop of the annular core portion 3 at one end of a cycle of the swing motions as indicated by solid lines in FIG. 8, and that the reel 51 is positioned inside the loop of the annular core portion 3 at the other end of the cycle of the swing motions as indicated by solid lines in FIG. 9.

The supply unit 50 for the second strand material 2 includes a pair of front and rear cassette stands 52 which are installed in an opposed relation to extend horizontally at a distance spaced from each other to such an extent as not interfering with the swing motions of the annular core portion 3 held by the holding arm 41. The cassette stands 52 include at their distal ends respective reel transfer mechanisms which are positioned to face each other while a plane including the annular core portion 3 is interposed between both the mechanisms.

The supply unit 50 comprises the reel 51 around which the second strand material 2 is rolled up, and a cassette 53 having a diameter slightly larger than an outer diameter of the reel 51 and having a cylindrical outer peripheral wall of which width corresponds to at least a reel inner width. The reel 51 is rotatably accommodated within the cassette 53 in a state that an entire surface of the rolled strand material 2 is covered, thus constituting a so-called cartridge. A reel-out hole is formed in the outer peripheral wall of the cassette 53, and the second strand material 2 is led out through the reel-out hole toward the clamping unit 43 which is located at the winding point for the annular core portion 3. The second strand material 2 is rolled up around the reel 51 at a pre-adjusted coil diameter and is set within the cassette 53 of the supply unit 50.

The pair of cassette stands 52 include, at their distal ends in opposed positions, guide rods to which the cassette 53 is detachably attached, and transfer mechanisms for transferring the cassette 53, which is attached to one of the guide rods, to the other guide rod. The transfer mechanisms are capable of transferring the cassette 53, which is attached to one of the guide rods, to the other guide rod by extending and retracting the guide rods by air cylinders such that one extended rod pushes a central portion of the cassette 53.

When using the production apparatus Ml constructed as described above, the annular metal cord C1 is produced through the following steps.

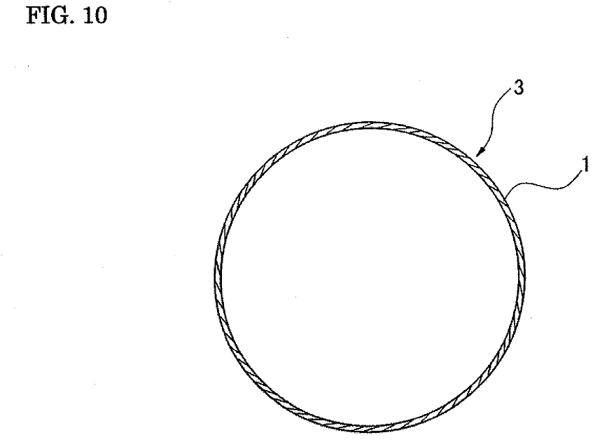

As shown in FIG. 10, the first strand material 1 is bent into an annular shape and the annular core portion 3 is formed by joining together the start end and the terminal end thereof by welding.

Next, the winding start end of the second strand material 2 is temporarily fixed to the annular core portion 3 by using an adhesive tape or the like. After the temporary fixing, the annular core portion 3 is set on the driving unit 40 of the production apparatus M1. The annular core portion 3 is then rotated in the circumferential direction to start winding of the second strand material 2 around the annular core portion 3.

In the case of the winding in Z-twist with rotation of the annular core portion 3 in the circumferential direction, from a state where the reel 51 including the second strand material 2 rolled up thereon is positioned on the left side with respect to the plane including the annular core portion 3 and the reel 51 is positioned outside the loop of the annular core portion 3 as indicated by the solid lines in FIG. 8, the annular core portion 3 is swung about the clamping unit 43 as a fulcrum to a position where the reel 51 comes into the inside of the loop of the annular core portion 3 as indicated by the solid lines in FIG. 9. Further, the reel 51 is moved perpendicularly to the plane including the annular core portion 3 by operating the air cylinder, which is disposed at the distal end of one cassette stand 52, for transfer of the cassette 53 to the guide rod of the other cassette stand 52, whereby half-turn winding of the second strand material 2 is performed. Then, from the state where the reel 51 is positioned inside the loop of the annular core portion 3 as indicated by the solid lines in FIG. 9, the annular core portion 3 is swung about the clamping unit 43 as a fulcrum to the position where the reel 51 comes out of the inside of the loop of the annular core portion 3 as indicated by the solid lines in FIG. 8. Further, the reel 51 is moved, along with the cassette 53, perpendicularly to the annular core plane again by operating the air cylinder in the outer side of the loop of the annular core portion 3, whereby one-turn winding of the second strand material 2 is completed. By repeating the above-described operation, the second strand material 2 constituting the outer layer portion 4 is spirally wound around the outer peripheral surface of the annular core portion 3.

Since the reel 51 reciprocally crosses the core plane of the annular core portion 3 at a predetermined position and the annular core portion 3 repeats swing motions about the clamping unit 43 as a fulcrum, which provides the winding point for the second strand material 2, the distance from the reel 51 to the winding point for the second strand material 2 is kept substantially constant. In the winding step, therefore, the second strand material 2 led out from the reel 51 can be avoided from loosening and the second strand material 2 can be wound around the annular core portion 3 under constant tension.

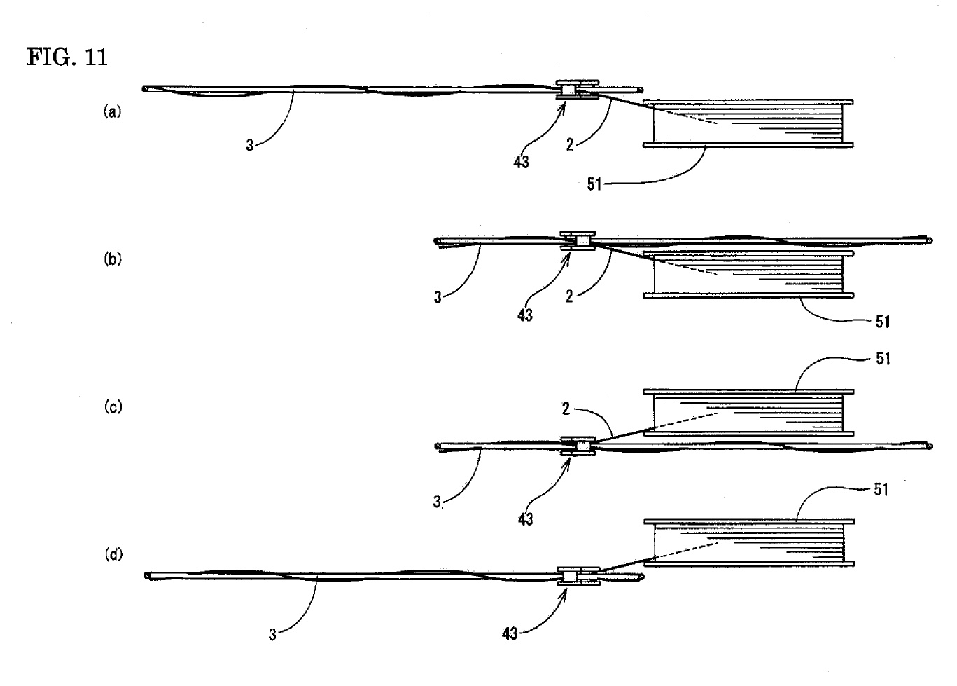

FIG. 11 shows the locus along which the reel 51 including the second strand material 2 rolled up thereon is moved, and the locus along which the annular core portion 3 repeats the swing motions.

More specifically, the following cycles are repeated. From a state where the reel 51 is positioned outside the annular core portion 3 as shown in FIG. 11(a), the annular core portion 3 is swung to a state where the reel 51 is positioned inside the loop of the annular core portion 3 as shown in FIG. 11(b). At the position shown in FIG. 11(b), the reel 51 is transferred from one side of the annular core portion 3 to the opposite side as shown in FIG. 11(c). Then, in the state where the reel 51 is positioned on the opposite side of the annular core portion 3, the annular core portion 3 is swung from a position shown in FIG. 11(c) to a state where the reel 51 is positioned outside the loop of the annular core portion 3 as shown in FIG. 11(d). Then, the reel 51 is returned from the opposite side of the annular core portion 3 to the start position (i.e., the position shown in FIG. 11(a)) on the original one side of the annular core portion 3. Thus, in this embodiment, the second strand material 2 is spirally wound around the annular core portion 3 by swinging the annular core portion 3 with respect to the reel 51 as represented by (a)→(b)→(c)→(d)→(a) in FIG. 11 and by moving the reel 51 perpendicularly to the core plane of the annular core portion 3 as represented by (b)→(c) and (d)→(a) in FIG. 11.

After completion of the winding of the second strand material 2, as shown in FIG. 6, the winding start end 2a and the winding terminal end 2b of the second strand material 2 are joined together by welding. As a result, the outer layer portion 4 constituted by the second strand material 2 can be obtained.

After welding the winding start end 2a and the winding terminal end 2b of the second strand material 2 in the joined portion 7, the annular core portion 3 and the outer layer portion 4 are subjected to a low-temperature annealing process. More specifically, heat treatment is performed on the annular core portion 3 and the outer layer portion 4 in a pressure chamber which is under vacuum or is supplied with argon in a depressurized atmosphere. Temperature in the heat treatment is set to 70-380° C. With the annealing process, internal strains of the first metal filament 5 and the second metal filament 6 can be removed and the annular metal cord C1 free from strains can be obtained.

Thereafter, in order to form the unsheathed portion 10A of the annular metal cord C1, a masking tape, such as an adhesive tape or a soft metal sheet tape, is annularly pasted to the entire circumference of the annular metal cord C1 on its annular outer-half peripheral surface.

A coating adhesive is applied over the outer peripheral surface of the annular metal cord C1, and the masking tape is removed after the applied coating adhesive has hardened.

By so doing, the annular metal cord C1 is covered with the outer layer sheath 10 at the outer peripheral side thereof, and the unsheathed portion 10A in the form of a slit is annularly formed in the outer layer sheath 10 over the entire circumference in its annular outer-half peripheral surface.

When the annular metal cord C1 thus produced is used, for example, in an endless metal belt of a continuously variable transmission described later, the endless metal belt can be obtained which is rotated without meandering. The endless metal belt capable of rotating without meandering causes no wears resulting from contact with surrounding parts, and therefore it can maintain high performance over a long term.

According to the first embodiment, as described above, since the annular metal cord C1 is covered with the outer layer sheath 10 made of the coating material having elasticity, the annular metal cord C1 can be made superior in break strength and fatigue resistance, as well as sturdy. Further, the presence of the outer layer sheath 10 can eliminate the problem that the first strand material 1 and the second strand material 2 are loosened and separated from each other. In addition, since the outer layer sheath 10 serves as a cushioning material, the following advantage is obtained. For example, even at a location where the annular metal cord C1 contacts, e.g., a pulley around which it is curved at a small radius of curvature, the presence of the outer layer sheath 10 increases frictional resistance between the annular metal cord C1 and the counterpart with which the former contacts. It is therefore possible to suppress a slippage, to minimize wear, and to obtain satisfactory power transmission efficiency. Consequently, the annular metal cord C1 can be suitably used as a satisfactory power transmission belt.

Moreover, the outer layer sheath 10 can be very easily formed for the purpose of reinforcement by applying the coating adhesive to a predetermined location and hardening the applied adhesive for secure bonding.

Since the unsheathed portion 10A is formed in the annular outer-half peripheral surface of the outer layer sheath 10 in at least one location, a lubricant can be smoothly permeated into the interior through the unsheathed portion 10A, thus suppressing a reduction of strength due to fretting wears between the annular core portion 3 and the outer layer portion 4, between adjacent parts of the second strand material 2 constituting the outer layer portion 4, and between the metal filaments 5 and 6 constituting respectively the strand materials 1 and 2, as well as shortening of the useful life due to fatigue.

Since the unsheathed portion 10A is annularly entirely formed in the annular outer-half peripheral surface of the outer layer sheath 10 in at least one location in the circumferential direction of a cross section of the outer layer portion 4, a lubricant can be smoothly permeated into the interior through the unsheathed portion 10A, and evenness in rigidity of the annular metal cord C1 can be improved over its entire annular circumference while suppressing a reduction of strength due to fretting wear between both the strand materials 1 and 2, as well as shortening of the useful life due to fatigue.

Since the coating material used as the outer layer sheath 10 has the hardness (JIS-A) of 22-60 and the elongation of 110-500% as physical properties after hardening, a high reinforcing effect can be obtained while ensuring flexibility and appropriate elongation.

If the hardness of the coating material after hardening is too high, the annular metal cord C1 would loose pliability. Conversely, if the hardness thereof is too low, a risk would arise in that the coating material is permanently deformed or scraped off upon contacting the counterpart. Also, if the coating material has not appropriate elongation, the annular metal cord C1 would have increased resistance against bending deformations and would be more susceptible to fatigue.

Furthermore, according to the above-described method of producing the annular metal cord C1 through the steps of pasting the masking tape to part of the annular metal cord C1 where the outer layer sheath 10 is not to be coated to form the unsheathed portion 10A, applying the coating adhesive, i.e., the coating material, over the outer peripheral surface of the annular metal cord C1, and removing the masking tape after the applied coating adhesive has hardened, the annular metal cord C1 can be easily produced which is covered with the outer layer sheath 10 made of the coating adhesive, is sturdy, is free from the problem of loosening and unwinding of the second strand material 2 constituting the outer layer portion 4, and which allows a lubricant to smoothly permeate into the interior.

In addition, according to the first embodiment, since the second strand material 2 formed by intertwisting seven second metal filaments 6 is wound around the first strand material 1 formed by intertwisting seven first metal filaments 5, the annular metal cord C1 can be made sturdy.

Also, since the first strand material 1 and the second strand material 2 are separately joined at both ends per material, a possibility that the annular metal cord C1 is completely breaked can be reduced in comparison with the case that the first strand material 1 and the second strand material 2 are joined respectively at their both ends all together. Stated another way, since the annular core portion 3 is formed by the first strand material 1 and the second strand material 2 is wound around the annular core portion 3 serving as an axial core, the annular 6 metal cord having high break strength can be obtained. When forming the outer layer portion 4, the second strand material 2 is wound around the first strand material 1 while running over its annular circumference six times instead of winding a plurality of second strand materials 2. Hence, a single second strand material 2 is just required. In comparison with the case using a plurality of second strand materials 2, therefore, the number of points at which the second strand materials are joined respectively at their both ends can be reduced, whereby a reduction of break strength of the annular metal cord C1 can be suppressed and production thereof can be facilitated. Since the second strand material 2 is wound at the predetermined winding angle, the winding of the second strand material 2 can be performed free from disorder and the annular metal cord C1 having a substantially uniform surface state can be obtained. The annular metal cord C1 having such a surface state is evenly subjected to externally applied forces, whereby a reduction of the break strength can be suppressed.

Further, the joined portion of the first strand material 1 and the joined position along the annular core portion 3. By so shifting the positions of the joined portions from each other, simultaneous break of the annular core portion 3 and the outer layer portion 4 is less apt to occur, and hence a reduction of break strength of the annular metal cord C1 can be suppressed.

While, in the above-described embodiment, the unsheathed portion 10A is formed in the shape of a slit which is annularly extended over the entire circumference of the outer layer sheath 10 in its annular outer-half peripheral surface, the unsheathed portion 10A is just required to be formed in at least one location in the annular outer-half peripheral surface of the outer layer sheath 10. Even in the latter case, a lubricant can be permeated into the interior through the unsheathed portion 10A. With such an arrangement, since an area of the unsheathed portion 10A is minimized, the reinforcing effect with the outer layer sheath 10 can be increased and the useful life can be prolonged.

Other examples of the unsheathed portion 10A will now be described.

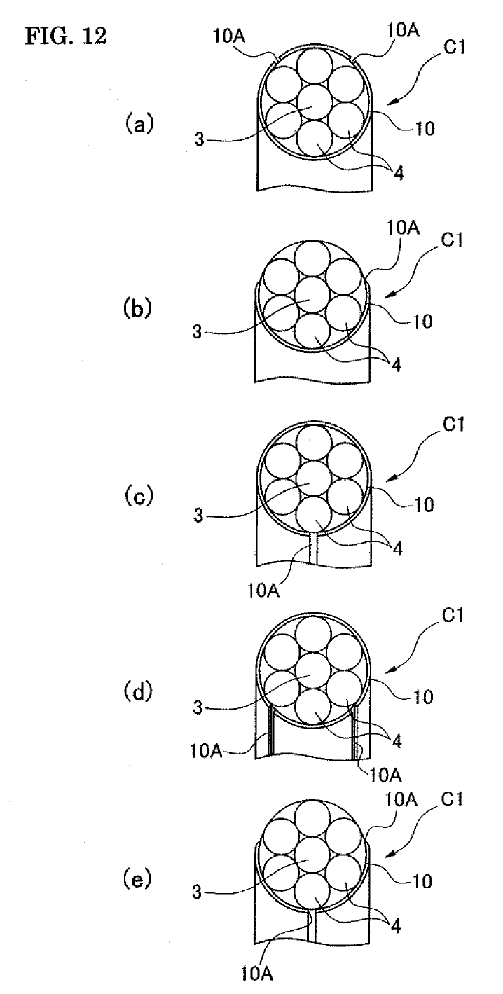

FIG. 12 is a sectional view showing the other examples of the unsheathed portion 10A.

FIG. 12(a) shows an example in which a plurality of unsheathed portions 10A are formed in the annular outer-half peripheral surface of the outer layer sheath 10 in at least one location or over its entire annular circumference. With the annular metal cord C1 having such a structure, a lubricant can be more smoothly permeated into the interior through the unsheathed portion 10A, thus suppressing a reduction of strength due to fretting wears between the annular core portion 3 and the outer layer portion 4, between adjacent parts of the second strand material 2 constituting the outer layer portion 4, and between the metal filaments 5 and 6 constituting respectively the strand materials 1 and 2, as well as shortening of the useful life due to fatigue.

FIG. 12(b) shows an example in which the annular outer-half peripheral surface of the outer layer sheath 10 is formed as the unsheathed portion 10A over its entire annular circumference. With the annular metal cord C1 having such a structure, a lubricant can be more smoothly permeated into the interior through the unsheathed portion 10A. In addition, the strand materials 1 and 2 can be held in an integral state while minimizing an increase of rigidity, which is caused with the provision of the outer layer sheath 10.

FIG. 12(c) shows an example in which one unsheathed portion 10A is formed in the annular inner-half peripheral surface of the outer layer sheath 10 in at least one location or over its entire annular circumference. With the annular metal cord C1 having such a structure, a lubricant can be smoothly permeated into the interior through the unsheathed portion 10A from the inner peripheral side of the annular metal cord, thus suppressing a reduction of strength due to fretting wears between the annular core portion 3 and the outer layer portion 4, between adjacent parts of the second strand material 2 constituting the outer layer portion 4, and between the metal filaments 5 and 6 constituting respectively the strand materials 1 and 2, as well as shortening of the useful life due to fatigue.

FIG. 12(d) shows an example in which a plurality of unsheathed portions 10A are formed in the annular inner-half peripheral surface of the outer layer sheath 10 in at least one location or over its entire annular circumference. With the annular metal cord C1 having such a structure, a lubricant can be more smoothly permeated into the interior through the unsheathed portions 10A from the inner peripheral side of the annular metal cord, thus suppressing a reduction of strength due to fretting wears between the annular core portion 3 and the outer layer portion 4, between adjacent parts of the second strand material 2 constituting the outer layer portion 4, and between the metal filaments 5 and 6 constituting respectively the strand materials 1 and 2, as well as shortening of the useful life due to fatigue.

FIG. 12(e) shows an example in which the annular outer-half peripheral surface of the outer layer sheath 10 is formed as the unsheathed portion 10A over its entire annular circumference, and another unsheathed portion 10A is further formed in the annular inner-half peripheral surface of the outer layer sheath 10 in at least one location or over its entire annular circumference. With the annular metal cord C1 having such a structure, a lubricant can be more smoothly permeated into the interior through the unsheathed portions 10A from both the outer and inner peripheral sides of the annular metal cord. In addition, the strand materials 1 and 2 can be held in an integral state while minimizing an increase of rigidity, which is caused with the provision of the outer layer sheath 10.

One example of an endless metal belt equipped with the annular metal cord C1 thus constructed will be described below.

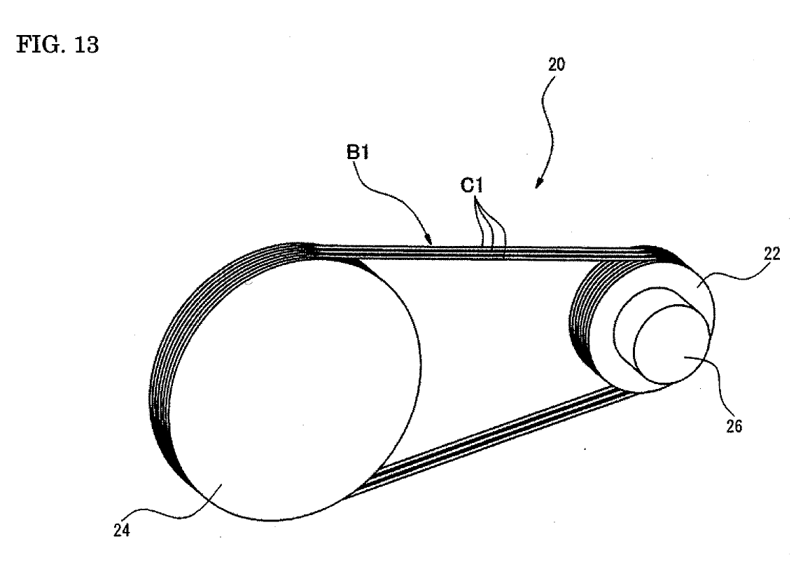

FIG. 13 is a schematic perspective view showing the endless metal belt according to this embodiment in a state during use.

An endless metal belt B1 is employed in a speed reducer 20 shown in FIG. 13, by way of example, which is used in precision machines and industrial machines. The endless metal belt B1 includes three annular metal cords C1 arranged in parallel and performs power transmission between a smaller-diameter drive pulley 22 and a larger-diameter driven pulley 24. A drive shaft of a driving motor 26 is connected to a rotation center of the drive pulley 22. Each of the drive pulley 22 and the driven pulley 24 has a circumferential groove formed in its outer periphery for stable stretching of each annular metal cord C1 between both the pulleys. With the endless metal belt B1 stretching between the drive pulley 22 and the driven pulley 24, a rotational force of the drive pulley 22 is transmitted to the driven pulley 24 through the endless metal belt B1. At that time, a rotational speed of the drive pulley 22 is reduced by the driven pulley 24 so that torque of the drive pulley 22 is increased by the driven pulley 24. The driven pulley 24 is connected, for example, to a shaft of another pulley (not shown) for further transmission of power.

The annular metal cord C1 has, as described above, very high break strength. Also, since the annular metal cord C1 has a substantially circular cross section, it is more durable against torsion than a cord having a rectangular cross section. In comparison with the case using a flat belt as the endless metal belt, therefore, the endless metal belt B1 constituted by using a plurality of annular metal cords C1 has very superior bending resistance and durability.

Note that the present invention is not limited to the above-described embodiment and it can be modified in various ways.

For example, while in the annular metal cord C1 of the first embodiment the outer layer sheath 10 is formed by hardening the coating adhesive, the outer layer sheath 10 may be made of rubber used for a tire or a belt.

In other words, the outer layer sheath 10 may be formed on the annular metal cord C1 by covering the annular metal cord C1 with rubber.

When the outer layer sheath 10 is formed by using rubber, the presence of the outer layer sheath 10 made of rubber around the annular metal cord C1 can also provide the following advantages. The annular metal cord C1 can be made superior in break strength and fatigue resistance, as well as sturdy. Further, the presence of the outer layer sheath 10 can eliminate the problem that the first strand material 1 and the second strand material 2 are loosened and separated from each other. In addition, the outer layer sheath 10 made of rubber serves as a cushioning material. Therefore, for example, even at a location where the annular metal cord C1 contacts, e.g., a pulley around which it is curved at a small radius of curvature, the presence of the outer layer sheath 10 increases frictional resistance between the annular metal cord C1 and the counterpart with which the former contacts. It is therefore possible to suppress a slippage, to minimize wear, and to obtain satisfactory power transmission efficiency. Consequently, the annular metal cord C1 can be suitably used as a power transmission belt.

Further, when the outer layer sheath 10 is made of rubber as described above, it adheres to the second strand material 2 because a sulfur component contained in the rubber reacts with plating of the second strand material 2.

Additionally, the outer layer sheath 10 made of rubber may be bonded to the second strand material 2 constituting the outer layer portion 4 by using a metal-rubber adhesive. Such a method is effective when the second strand material 2 is not plated. Stated another way, even when the second strand material 2 is not plated, the rubber can be reliably fixed to the second strand material 2 and the reinforcing effect can be increased. For example, Chemlock (made by Lord Fareast Incorporated) can be used as the metal-rubber adhesive.

Moreover, the rubber used as the outer layer sheath 10 is preferably vulcanized at a vulcanization pressure of 8 MPa or lower. By so setting the vulcanization pressure, penetration of the rubber into the interior can be prevented while allowing satisfactory permeation of a lubricant, thus suppressing a reduction of strength due to the friction between the annular core portion 3 and the outer layer portion 4, between adjacent parts of the second strand material 2 constituting the outer layer portion 4, and between the metal filaments 5 and 6 constituting respectively the strand materials 1 and 2, as well as shortening of the useful life due to fatigue.

A method of forming the outer layer sheath 10 using rubber will now be described.

First, a masking tape, such as an adhesive tape or a soft metal sheet tape, is pasted to the annular metal cord C1 in a predetermined location where the unsheathed portion 10A is to be formed.

Then, tape-like raw rubber is pasted over the outer peripheral surface of the annular metal cord C1 by spirally winding the raw rubber around it.

Subsequently, a woven fabric is wound around the annular metal cord C1 to which the raw rubber has been pasted as described above. After putting the thus-prepared annular metal cord C1 in a vulcanizing pan, pressurized water vapor is introduced to the vulcanizing pan for pressurization.

As a result, the raw rubber wound around the annular metal cord C1 and having plasticity is vulcanized to become vulcanized rubber having elasticity.

Alternatively, the vulcanized rubber can also be obtained through the steps of arranging the annular metal cord C1 in one of a pair of molds having an annular groove in a semicircular shape as viewed in a cross section, putting the other mold on the one, putting the pair of mated molds in a vulcanizing pan, and introducing pressurized water vapor to the vulcanizing pan for pressurization.

Thereafter, the masking tape is removed from the annular metal cord C1 which has been taken out from the vulcanizing pan.

By so doing, the annular metal cord C1 is covered with the outer layer sheath 10 made of the rubber at the outer peripheral side thereof, and the unsheathed portion 10A is formed in the outer layer sheath 10.

Further, by employing a method of producing the annular metal cord C1, which is covered with the outer layer sheath 10 made of rubber, through the steps of, as described above, pasting a masking tape to the annular metal cord C1 in its part where the outer layer sheath 10 is not to be coated to form the unsheathed portion 10A, pasting raw rubber over the outer peripheral surface of the annular metal cord C1, and removing the masking tape after a pressurization and vulcanization process, the annular metal cord C1 can be easily produced which is covered with the outer layer sheath 10 made of the rubber, is sturdy, is free from the problem of loosening and unwinding of the second strand material 2 constituting the outer layer portion 4, and which allows a lubricant to smoothly permeate into the interior.

Moreover, in the annular metal cord C1 of the first embodiment, the second strand material 2 is wound along the outer peripheral surface of the annular core portion 3 while running over its annular circumference six times. However, when the first strand material 1 and the second strand material 2 differ in diameter, the second strand material 2 may wound around the annular core portion 3, which has a larger diameter, while running over its annular circumference seven or eight times.

In the annular metal cord C1 of the first embodiment, as shown in FIG. 5(a), one layer of the second strand material 2 covers the outer peripheral surface of the annular core portion 3. As an alternative, the outer peripheral surface of the annular core portion 3 may be covered with plural layers of the second strand material 2. For example, when the outer peripheral surface of the annular core portion 3 is covered with two layers of the second strand material 2, a first layer is formed by winding the second strand material 2 around the outer peripheral surface of the annular core portion 3 while running over its annular circumference six times, and then a second layer is formed by winding the second strand material 2 around an outer peripheral surface of the first layer while running over its annular circumference twelve times.

In the annular metal cord C1 of the first embodiment, the first strand material 1 and the second strand material 2 are each itself formed in the S-twist and the second strand material 2 is wound around the annular core portion 3 in the Z-twist. However, the first strand material 1 and the second strand material 2 may be each itself formed in the Z-twist and the second strand material 2 may be wound around the annular core portion 3 in the S-twist.

While the annular metal cord C1 of the first embodiment has a substantially circular cross section as shown in FIG. 5(a), it may have a flattened sectional shape. In such a case, the annular metal cord C1 having a substantially circular cross section is deformed, for example, by using a press. Deforming the annular metal cord C1 into the flattened sectional shape increases a contact area between the endless metal belt B1, which includes the flattened annular metal cord C1, and each of the drive pulley 22 and the driven pulley 24. As a result, power transmission between the drive pulley 22 and the driven pulley 24 can be performed with higher efficiency. Note that an aspect ratio is preferably 66% or more.

While in the endless metal belt B1 of this embodiment three annular metal cords C1 are stretched between the drive pulley 22 and the driven pulley 24, the number of annular metal cords C1 stretched is not limited to three. The number of annular metal cords C1 can be adjusted depending on bending resistance and durability which are required in individual cases.

### Second Embodiment

An annular metal cord according to a second embodiment will be described with reference to the drawings. Comparing with the annular metal cord according to the first embodiment which is constituted by the first strand material and the second strand material, the annular metal cord according to the second embodiment has a common structure except that it is constituted by a single strand material. The following description is made by denoting identical constructions and identical components to those in the first embodiment at the same reference numerals.

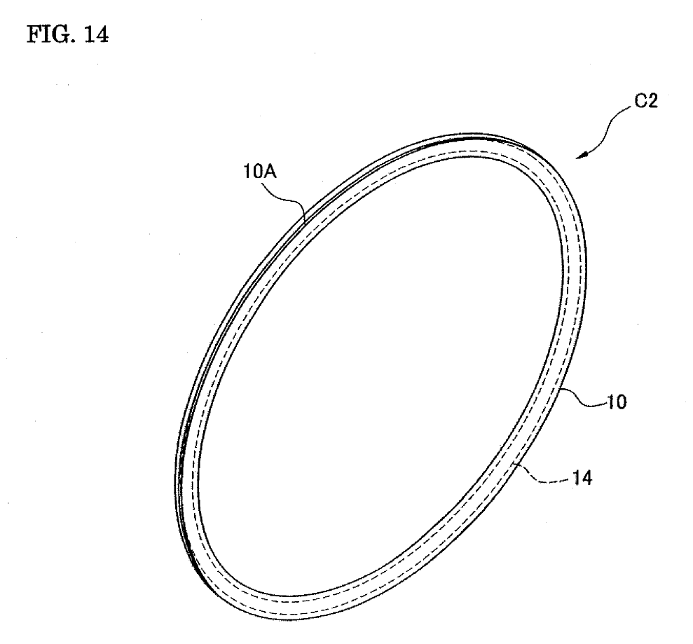

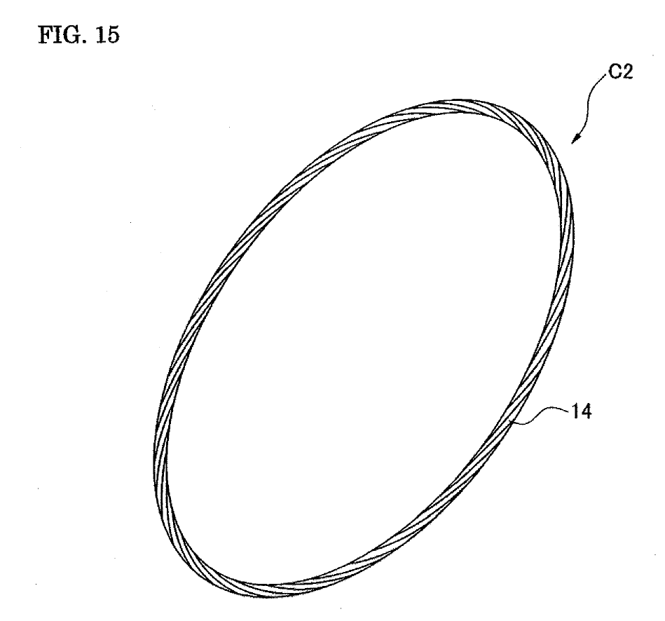

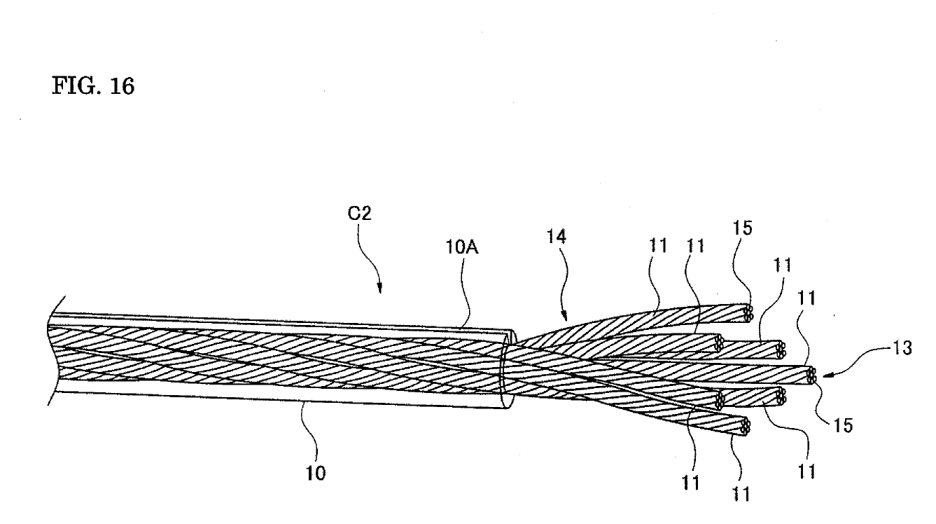

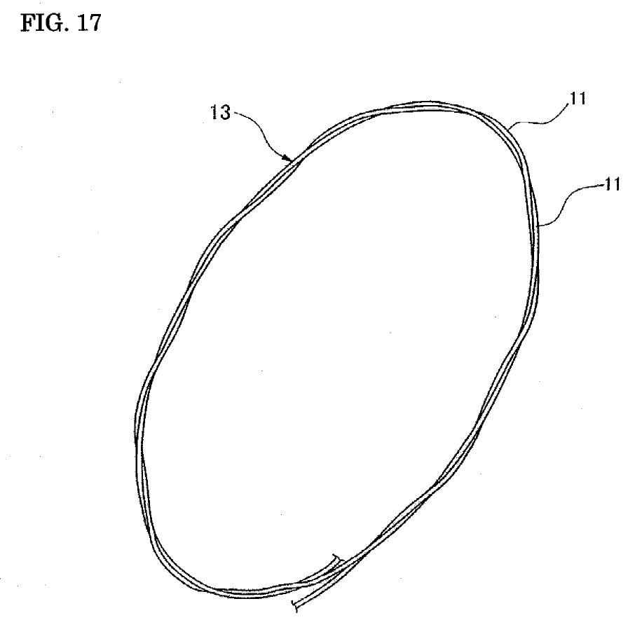

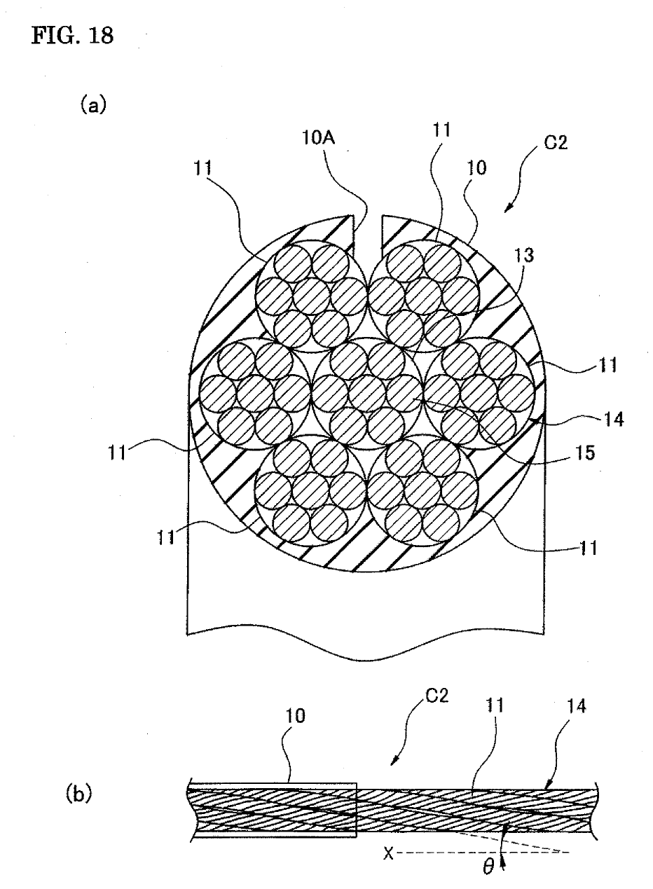

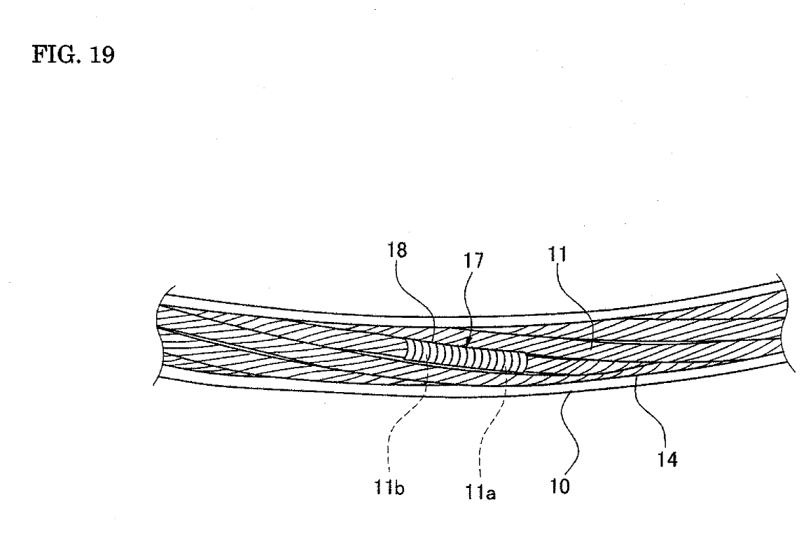

FIG. 14 is a perspective view of the annular metal cord according to the second embodiment, FIG. 15 is a perspective view of the annular metal cord according to the second embodiment in a state before an outer layer sheath is formed, and FIG. 16 is a perspective view showing the annular metal cord, radially sectioned, according to the second embodiment. FIG. 17 is a perspective view showing a state where a strand material is wound around an annular core portion while running over its annular circumference once, which is included in the annular metal cord according to the second embodiment. FIG. 18(a) is a radial sectional view showing the annular metal cord according to the second embodiment, and FIG. 18(b) is a side view of the annular metal cord according to the second embodiment. FIG. 19 is an enlarged perspective view showing part of the annular metal cord according to the second embodiment.

As shown in FIG. 14, an annular metal cord C2 is covered at its outer peripheral side with an outer layer sheath 10. The outer layer sheath 10 is made of the same material and has the same constitution as those in the first embodiment, and it is formed by applying a coating adhesive and hardening the applied adhesive. Alternatively, the annular metal cord C2 may also be made of rubber as described in the first embodiment.

The annular metal cord C2 has an unsheathed portion 10A in which the outer layer sheath 10 is not coated. The unsheathed portion 10A is formed in the shape of a slit which is annularly extended over an entire circumference of the outer layer sheath 10 in its annular outer-half peripheral surface.

As shown in FIGS. 15 and 16, the annular metal cord C2 includes an annular core portion 13 and an outer layer portion 14 covering an outer peripheral surface of the annular core portion 13.

The annular core portion 3 is formed, as shown in FIG. 17, by bending a strand material 11 to make a round, i.e., into an annular shape, with a predetermined diameter. The outer layer portion 4 surrounding the annular core portion 13 is formed by continuously winding the stand material 11, which constitutes the annular core portion 13, around the annular core portion 13 with the annular core portion 13 serving an axial core.

As shown in FIG. 18(a), the strand material 11 is formed by intertwisting a plurality of metal filaments 15. In the second embodiment, as illustrated in FIG. 16, the strand material 11 is constituted such that one of the metal filaments 15 is situated at a center and other six strand filaments 15 are wound in S-twist around an outer peripheral surface of the metal filament 15 at the center. Thus, since the strand material 11 is in the geometrically stable form made up of seven intertwisted filaments, it is sturdy and is hard to break.

Each of the metal filaments 15 is made of high-carbon steel containing 0.60 mass % or more of C. By selecting a material containing 0.60 mass % or more of C, the metal filament 15 can be obtained as a steel wire having more superior break strength. Note that the material composition of the metal filament 15 is not limited to the above-described one.

The metal filament 15 has a diameter in the range of not smaller than 0.06 mm, but not larger than 0.40 mm. Herein, since the diameter of the metal filament 15 is 0.06 mm or larger, the strand material 11 has sufficient rigidity and the annular core portion 13 can be made less apt to deform. In addition, since the diameter of the metal filament 15 is 0.40 mm or smaller, the rigidity of the strand material 11 can be kept from increasing beyond a proper level and the annular metal cord C2 can be made less apt to cause a fatigue break due to repeated applied stresses.

Thus, by using the metal filament 15 having such a diameter to form the strand material 11, the strand material 11 having appropriate rigidity can be obtained. As a result, the strand material 11 can be easily wound around the annular core portion 13 and loosening of the wound strand material 11 is less apt to occur.

The strand material 11 is spirally wound around the annular core portion 13 while running over its annular circumference plural times, as shown in FIGS. 16 and 17. The strand material 11 is wound in a manner causing no torsion. By the winding with no torsion, loosing of the wound strand material 11 can be suppressed.

In the second embodiment, the strand material 11 constituting the outer layer portion 14 is wound along the outer peripheral surface of the annular core portion 13 while running over its annular circumference six times. Since the strand material 11 wound around the annular core portion 13 is constituted by a single strand material 11, which is continuously used in common after forming the annular core portion 13, and the strand material 11 is wound around the outer peripheral surface of the annular core portion 13 while running over its annular circumference six times, the strand material 11 can be wound without leaving substantially no gaps. Accordingly, the outer layer portion 14 closely covers the annular core portion 13. The annular metal cord C2 has a cross section that, as shown in FIG. 18(a), six parts of the strand materials 11 are arrayed around the strand material 11 serving as the annular core portion 13.

As shown in FIG. 17, the strand material 11 constituting the outer layer portion 14 is wound in Z-twist around the outer peripheral surface of the annular core portion 13. Since the strand material 11 is in itself formed by winding the filaments in S-twist, the annular metal cord C2 has a structure including the S-twist and the Z-twist in a mixed state. In other words, since the twist direction of the metal filament 15 and the winding direction of the outer layer portion 14 with respect to the annular core portion 13 are opposed to each other, the annular metal cord C2 can be obtained which is hard to cause torsion and has less ruggedness in its external appearance.

In addition, the strand material 11 constituting the outer layer portion 14 is wound at a predetermined winding angle with respect to a center axis of the annular core portion 13. Therefore, the strand material 11 can be wound without disorder, and the annular metal cord C2 having a substantially uniform surface state can be obtained. In the second embodiment, as shown in FIG. 18(b), a winding angle θ of the strand material 11 with respect to the X-direction, i.e., the direction in which the center axis of the annular core portion 13 extends, is not smaller than 4.5 degrees, but not larger than 13.8 degrees. By setting the winding angle θ to be 4.5 degrees or larger, the loosing of the wound strand material 11 can be made less apt to occur. By setting the winding angle θ to be 13.8 degrees or smaller, the elongation of the strand material 11 can be prevented from increasing excessively. In other words, by setting the winding angle θ of the strand material 11, which is wound around the annular core portion 13 and constitutes the outer layer portion 14, to be not smaller than 4.5 degrees, but not larger than 13.8 degrees, the annular metal cord C2 having appropriate elongation and being easy to bend can be obtained. When the annular metal cord C2 having such properties is used, for example, in the above-described endless metal belt, power transmission between the drive pulley and the driven pulley can be performed with high accuracy.

As shown in FIG. 19, a winding start end 11a and a winding terminal end 11b of the strand material 11 constituting each of the annular core portion 13 and the outer layer portion 14 are joined together by welding. Further, a joined portion 17 between both the winding ends is covered with a connecting member 18.

More specifically, the connecting member 18 is constituted by a sleeve which is in the form of a coil spring and has superior flexibility. The connecting member 18 is fixed in place by an adhesive so as to cover an outer periphery of the joined portion 17 between both the ends of the strand material 11, i.e., the start end 11a and the terminal end 11b thereof. The connecting member 18 formed of the coil spring sleeve is pliably deformed in match with a curved shape of the strand material 11, thereby protecting and reinforcing the welded portion of the strand material 11.

Thus, by joining together the start end 11a and the terminal end 11b of the strand material 11 by using the connecting member 18 which is formed of the coil spring sleeve and which has superior flexibility, the connecting member 18 can be attached in a state satisfactorily covering the joined portion 17 in match with its shape in which the start end 11a of the strand material 11 constituting the annular core portion 13 is joined to the terminal end 11b of the strand material 11 which constitutes the outer layer portion 14 and is inclined relative to the start end 11a. Accordingly, the joined portion 17 between the start end 11a and the terminal end 11b of the strand material 11 can be satisfactorily protected. Further, since the connecting member 18 does not impede deformation of the strand material 11 in the joined portion 17, flexibility of the strand material 11 can be held at an even level between the joined portion 17 and the other portion, whereby mechanical characteristics of the annular metal cord C2 can be made substantially uniform over its entire circumference.

In addition, the joined portion 17 between the start end 11a and the terminal end 11b is located in one of opposite side areas of a circular arc defined by the annular metal cord C2 except for inner and outer peripheral sides of the circular arc. With such an arrangement, even when the annular metal cord C2 is deformed in the radial direction, a load acting on the joined portion 17 can be reduced and a break in the joined portion 17 can be suppressed.

As described above, the annular metal cord C2 is formed by winding the strand material 11, which constitutes the outer layer portion 14, around the strand material 11 which constitutes the annular core portion 13, and then joining together the start end 11a and the terminal end 11b of the strand material 11 by using the connecting member 18.

The joined portion 17 in the second embodiment may be modified so as to have a structure connected only by welding without providing the connecting member 18 therein. Also, the connecting member 18 in the second embodiment may be provided in the joined portion 7 in the first embodiment. Anyway, since the joined portion of the strand material 11 is covered and protected by the outer layer sheath 10, it is ensured that the annular metal cord has the required strength.

Subsequently, a method of producing the annular metal cord C2 will be described. A production apparatus shown in FIGS. 7-9 can also be used herein as in the first embodiment.

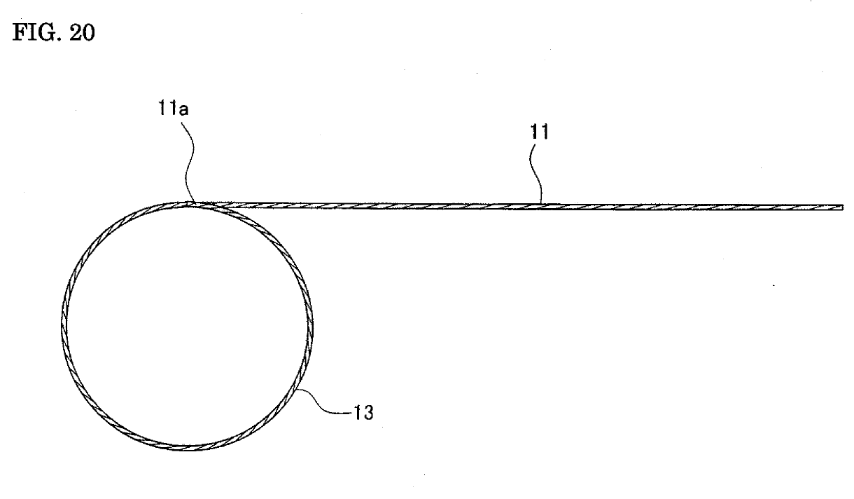

First, as shown in FIG. 20, a single strand material 11 is bent in its start end side into an annular shape, thus forming the annular core portion 13.

Next, an overlapped portion of the strand material 11 near the start end 11a is temporarily fixed together by using an adhesive tape, a string, a spring or the like.

After temporary fixing, the annular core portion 13 is set on the driving unit 40 of the production apparatus Ml (see FIGS. 7-9). The annular core portion 13 is then rotated in the circumferential direction to start winding of the strand material 11 around the annular core portion 13.

The winding of the strand material 11 is performed as in the first embodiment, i.e., as shown in FIG. 11, such that the strand material 11 constituting the outer layer portion 14 is spirally wound around the outer peripheral surface of the annular core portion 13.

After completion of the winding of the strand material 11, the winding terminal end 11b of the strand material 11 is inserted to the connecting member 18 and the temporary fixing near the start end 11a is released. The start end 11a and the terminal end 11b are then joined together by welding. Subsequently, an adhesive is applied to the joined portion 17 between the start end 11a and the terminal end 11b, and the connecting member 18 is slid to a position where it covers the joined portion 17. Thus, the connecting member 18 is fixed to the joined portion 17 by the adhesive as shown in FIG. 19. As a result, the joined portion 17 is protected by the connecting member 18 and a break at the joined point can be suppressed.

Herein, the terminal end of the strand material 11 nearer to the outer peripheral layer 14 is inclined relative to the start end 11a nearer to the annular core portion 13, thereby causing slight bending of the joined portion 17. However, since the connecting member 18 is formed of the coil spring sleeve and has superior flexibility, the connecting member 18 can be easily fitted over the joined portion 17.

By winding the strand material 11 around the annular core portion 13 and joining together the start end 11a and the terminal end 11b thereof as described above, the outer layer portion 4 can be formed around the annular core portion 13.

After joining together the start end 11a and the terminal end 11b by using the connecting member 18, the annular core portion 13 and the outer layer portion 14 are subjected to a low-temperature annealing process in the same manner as in the first embodiment. With the annealing process, internal strains of the metal filament 15 can be removed and the annular metal cord C2 free from strains can be obtained.

Thereafter, as in the first embodiment, a masking tape is pasted to the annular metal cord C2 in a predetermined location where the unsheathed portion 10A is to be formed. A coating adhesive is applied over the outer peripheral surface of the annular metal cord C2, and the masking tape is removed after the applied coating adhesive has hardened.

By so doing, the annular metal cord C2 is covered with the outer layer sheath 10 at the outer peripheral side thereof, and the unsheathed portion 10A is formed in the outer layer sheath 10 over the circumference in its annular outer-half peripheral surface.

When the annular metal cord C2 thus produced is used, for example, in the above-described endless metal belt, the endless metal belt can be obtained which is rotated without meandering. The endless metal belt capable of rotating without meandering causes no wears resulting from contact with surrounding parts, and therefore it can maintain high performance over a long term.

According to the second embodiment also, as described above, since the annular metal cord C2 is covered with the outer layer sheath 10 made of the coating material having elasticity, the annular metal cord C2 can be made superior in break strength and fatigue resistance, as well as sturdy. Further, the presence of the outer layer sheath 10 can eliminate the problem that the strand material 11 is loosened and unwound. In addition, since the outer layer sheath 10 serves as a cushioning material, the following advantage is obtained. For example, even at a location where the annular metal cord C2 contacts, e.g., a pulley around which it is curved at a small radius of curvature, the presence of the outer layer sheath 10 increases frictional resistance between the annular metal cord C2 and the counterpart with which the former contacts. It is therefore possible to suppress a slippage, to minimize wear, and to obtain satisfactory power transmission efficiency. Consequently, the annular metal cord C2 can be suitably used as a satisfactory power transmission belt.

Moreover, the outer layer sheath 10 can be very easily formed for the purpose of reinforcement by applying the coating adhesive to a predetermined location and hardening the applied adhesive for secure bonding.

Since the unsheathed portion 10A is formed in the annular outer-half peripheral surface of the outer layer sheath 10, a lubricant can be smoothly permeated into the interior through the unsheathed portion 10A. Therefore, a reduction of strength due to fretting wears and shortening of the useful life due to fatigue can be suppressed, the fretting wears being caused between the annular core portion 3 and the outer layer portion 4, between adjacent parts of the strand material 11, and between the metal filaments 15 constituting the strand material 11.

Since the unsheathed portion 10A is annularly entirely formed, a lubricant can be smoothly permeated into the interior through the unsheathed portion 10A, and evenness in rigidity of the annular metal cord C2 can be improved over its entire annular circumference while suppressing a reduction of strength due to fretting wear between adjacent parts of the strand material 11, as well as shortening of the useful life due to fatigue.

Since the coating material used as the outer layer sheath 10 has the hardness (JIS-A) of 22-60 and the elongation of 110-500% as physical properties after hardening, a high reinforcing effect can be obtained while ensuring flexibility and appropriate elongation.

If the hardness of the coating material after hardening is too high, the annular metal cord C2 would loose pliability. Conversely, if the hardness thereof is too low, a risk would arise in that the coating material is permanently deformed or scraped off upon contacting the counterpart. Also, if the coating material has not appropriate elongation, the annular metal cord C2 would have increased resistance against bending deformations and would be more susceptible to fatigue.

Furthermore, according to the above-described method of producing the annular metal cord C2 through the steps of pasting the masking tape to part of the annular metal cord C2 where the outer layer sheath 10 is not to be coated to form the unsheathed portion 10A, applying the coating adhesive, i.e., the coating material, over the outer peripheral surface of the annular metal cord C2, and removing the masking tape after the applied coating adhesive has hardened, the annular metal cord C2 can be easily produced which is covered with the outer layer sheath 10 made of the coating adhesive, is sturdy, is free from the problem of loosening and unwinding of the strand material 11 constituting the outer layer portion 14, and which allows a lubricant to smoothly permeate into the interior.

In addition, according to the second embodiment, the strand material 11 formed by intertwisting seven metal filaments 15 is used itself as the annular core portion 13 and is spirally wound around the annular core portion 13 while running over its annular circumference plural times, thereby forming the outer layer portion 14 to cover the outer peripheral surface of the annular core portion 13. Thus, since the annular core portion 13 and the outer layer portion 14 are both formed by the continuous strand material 11, the annular metal cord C2 can be made sturdy and a possibility that the annular metal cord C2 is completely broken can be reduced in comparison with the related art in which a plurality of strand materials are joined respectively at their both ends at one concentrated location in the circumferential direction. Stated another way, since the annular core portion 13 is formed by using the strand material 11 as it is and the strand material 11 is continuously wound around the annular core portion 13 serving as an axial core, the annular metal cord having high break strength can be obtained. Further, since external forces applied to the annular metal cord C2 can be borne by the annular core portion 13 and the outer layer portion 14 which are continuous in the form of one strand material, the applied external forces can be dispersed over the entire annular metal cord C2 so as to avoid local concentration of load.

Moreover, when forming the outer layer portion 14, the strand material 11 constituting the annular core portion 13 is continuously wound around the annular core portion 13 while running over its annular circumference six times instead of winding a plurality of strand materials 11. Hence, a single strand material 11 is just required. In comparison with the case using a plurality of strand materials 11, therefore, the number of points at which the strand materials are joined respectively at their both ends can be reduced, whereby a reduction of break strength of the annular metal cord C2 can be suppressed and production thereof can be facilitated. Further, since the strand material 11 constituting the outer layer portion 14 is wound at the predetermined winding angle, the winding of the strand material 11 can be performed free from disorder and the annular metal cord C2 having a substantially uniform surface state can be obtained. The annular metal cord C2 having such a surface state is evenly subjected to externally applied forces, whereby a reduction of the break strength can be suppressed.

While, in the above-described second embodiment, the unsheathed portion 10A is formed in the shape of a slit which is annularly extended over the entire circumference of the outer layer sheath 10 in its annular outer-half peripheral surface, the unsheathed portion 10A is just required to be formed in at least one location in the annular outer-half peripheral surface of the outer layer sheath 10. Even in the latter case, a lubricant can be permeated into the interior through the unsheathed portion 10A. With such an arrangement, since an area of the unsheathed portion 10A is minimized the reinforcing effect with the outer layer sheath 10 can be increased and the useful life can be prolonged.

In the second embodiment, the unsheathed portion can also be formed in any of various examples, shown in FIG. 12, which have been described above in connection with the first embodiment. Similar advantages to those in the first embodiment can be obtained with the various examples as well.

The annular metal cord C2 according to the second embodiment can also be used in the endless metal belt shown in FIG. 13.

Since the annular metal cord C2 has very high break strength as described above, the endless metal belt using the annular metal cord C2 has very superior bending resistance and durability.

Note that the annular metal cord C2 according to the second embodiment is not limited to the above-described embodiment and it can also be modified in various ways.

For example, in the annular metal cord C2 of the second embodiment, the outer layer sheath 10 may also be made of rubber used for a tire or a belt.

In other words, the outer layer sheath 10 may be formed on the annular metal cord C2 by covering the annular metal cord C2 with rubber. As described above in connection with the first embodiment, even when the outer layer sheath 10 is formed by using rubber, the annular metal cord C2 can be made superior in break strength and fatigue resistance, as well as sturdy.

When forming the annular core portion 13 in the annular metal cord C2 of the above-described embodiment, the strand material 11 may be temporarily fixed in the overlapped portion, while leaving an extra extension of the strand material 11 at one end side, such that part of the outer layer portion 14 is constituted by the extra extension of the strand material 11.

In the annular metal cord C2 of the second embodiment, as shown in FIG. 18(a), one layer of the strand material 11 covers the outer peripheral surface of the annular core portion 13. As an alternative, the outer peripheral surface of the annular core portion 13 may be covered with plural layers of the strand material 11. For example, when the outer peripheral surface of the annular core portion 13 is covered with two layers of the strand material 11, a first layer is formed by winding the strand material 11 around the outer peripheral surface of the annular core portion 13 while running over its annular circumference six times, and then a second layer is formed by winding the strand material 11 around an outer peripheral surface of the first layer while running over its annular circumference twelve times. On that occasion, the direction in which the strand material 11 is wound to form the second layer while running over the annular circumference twelve times is preferably set to be opposite to the direction in which the strand material 11 is wound to form the first layer while running over the annular circumference six times. Such setting of the winding direction is important from the viewpoint of obtaining a satisfactory winding property and an external surface with less ruggedness.

In the annular metal cord C2 of the second embodiment, the strand material 11 is formed in the S-twist and the strand material 11 constituting the outer layer portion 14 is wound around the annular core portion 13 in the Z-twist. However, the strand material 11 may be formed in the Z-twist and the strand material 11 constituting the outer layer portion 14 may be wound around the annular core portion 13 in the S-twist.

While the annular metal cord C2 of the second embodiment has a substantially circular cross section as shown in FIG. 18(a), it may have a flattened sectional shape as in the first embodiment described above.

### Third Embodiment

An annular metal cord according to a third embodiment will be described with reference to the drawing.

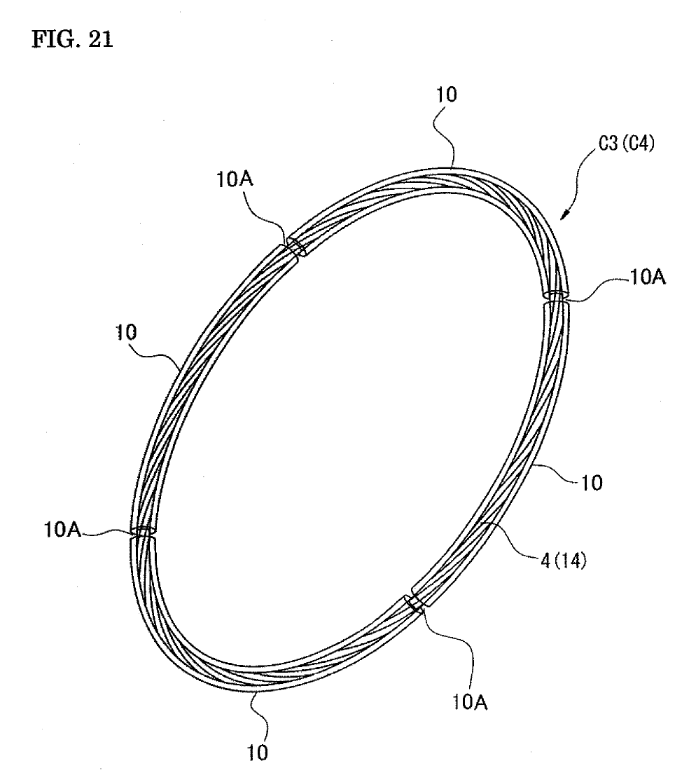

As shown in FIG. 21, an annular metal cord C3 according to the third embodiment includes an annular core portion 3 and an outer layer portion 4 which are similar to those in the annular metal cord C1 according to the first embodiment, but an outer layer sheath 10 is provided on an outer peripheral surface of the outer layer portion 4 in the form different from that in the first embodiment. In the annular metal cord C3, there are alternately formed a sheathed portion 10 in which the outer layer portion 4 is covered with an outer layer sheath and an unsheathed portion 10A in which the outer layer sheath is not formed and the outer layer portion 4 is exposed. The sheathed portion 10 having the outer layer sheath is formed by applying a coating adhesive which is similar to that used in the first and second embodiments, and hardening the applied coating adhesive. Alternatively, the sheathed portion 10 is formed of rubber which is similar to that used in the first and second embodiments.

The sheathed portion 10 coated with the outer layer sheath is formed to be longer than the unsheathed portion 10A such that at least part of the outer layer portion 4 including the joined portion 7 (see FIG. 6) between the winding start end and the winding terminal end of the outer layer portion 4 is covered, including the vicinity of the joined portion, with the outer layer sheath.

The annular core portion 3 may have an adhesive coated portion in which the coating adhesive is applied and hardened on the outer peripheral surface of the annular core portion 3. In the case of forming the adhesive coated portion, the adhesive coated portion and an adhesive uncoated portion in which the coating adhesive is not applied are alternately formed. Preferably, the adhesive coated portion is formed on the annular core portion 3 to be longer than the adhesive uncoated portion, and the unsheathed portion 10A in which the outer layer portion 4 is not covered with the outer layer sheath and the adhesive uncoated portion in which the annular core portion 3 is not covered with the coating adhesive are located at positions differing from each other in the circumferential direction.

The coating adhesive used to form the adhesive coated portion on the annular core portion 3 can be similar to the coating adhesive used to form the outer layer sheath.

The annular core portion 3 has a similar construction to that in the first embodiment, and it is formed by joining together both the ends of the first strand material 1.

The outer layer portion 4 also has a similar construction to that in the first embodiment, and it is formed by winding the second strand material 2 around the annular core portion 3 which serves as an axial core.

A method of producing the annular metal cord C3 is also similar to the method of producing the annular metal cord C1 except for the difference in the forms of the sheathed portion 10 and the unsheathed portion 10A.

When the adhesive coated portion is provided on the annular core portion 3, the coating adhesive is applied to and hardened in predetermined locations on the outer peripheral surface of the annular core portion 3 such that the adhesive coated portion in which the coating adhesive is applied and hardened and the adhesive uncoated portion in which the coating adhesive is not applied are alternately formed.

When the annular metal cord C3 is used, for example, in the above-described endless metal belt B1 (see FIG. 13), the endless metal belt can be obtained which is rotated without meandering. The endless metal belt capable of rotating without meandering causes no wears resulting from contact with surrounding parts, and therefore it can maintain high performance over a long term.

According to the third embodiment, since the joined portion 7 between the winding start end 2a and the winding terminal end 2b of the second strand material 2, which constitutes the outer layer portion 4, is covered, including the vicinity of the joined portion, with the outer layer sheath, the annular metal cord C3 can be made sturdy. In particular, the joined portion 7 between the winding start end 2a and the winding terminal end 2b of the second strand material 2, which constitutes the outer layer portion 4, can be firmly reinforced. Further, such covering can eliminate the problem that the second metal filaments 6 constituting the second strand material 2 are loosened and unwound.

In addition, since the sheathed portion 10 coated with the outer layer sheath and the unsheathed portion 10A not coated with the outer layer sheath are alternately formed over the entire circumferential surface and the entire length of the outer layer portion 4, a lubricant, such as machine oil, can be smoothly permeated into the interior through the unsheathed portion 10A, thus suppressing a reduction of strength due to the friction between the annular core portion 3 and the outer layer portion 4, between adjacent parts of the second strand material 2 constituting the outer layer portion 4, and between the metal filaments 5 and 6 constituting respectively the strand materials 1 and 2, as well as shortening of the useful life due to fatigue.

Moreover, since the sheathed portion 10 is formed to be longer than the unsheathed portion 10A such that the unsheathed portion 10A has the least necessary length for permeation of a lubricant into the interior and the sheathed portion 10 has a length as long as possible, the reinforcing effect can be increased and the useful life can be prolonged.

The unsheathed portion 10A is just required to be formed in at least one location in the circumferential direction of the outer layer portion 4. Even in such a case, a lubricant can be permeated into the interior through the unsheathed portion 10A. With such an arrangement, since an area of the unsheathed portion 10A is minimized, the reinforcing effect with the outer layer sheath 10 can be increased and the useful life can be prolonged.

Further, by alternately forming, on the outer peripheral surface of the annular core portion 3, the adhesive coated portion in which the coating adhesive is applied and hardened and the adhesive uncoated portion in which the coating adhesive is not applied, the annular core portion 3 can be reinforced in itself with the provision of the adhesive coated portion and the strength of the annular metal cord C3 can be increased. Also, the provision of the adhesive uncoated portion enables a lubricant to be smoothly permeated into the interior of the annular core portion 3 through the adhesive uncoated portion, thus suppressing a reduction of strength due to the friction between the first metal filaments 5 constituting the first strand material 1 which serves as the annular core portion 3, as well as shortening of the useful life due to fatigue.

Additionally, by shifting the position of the unsheathed portion 10A not coated with the outer layer sheath and the position of the adhesive uncoated portion on the annular core portion 3 from each other in the circumferential direction, a reduction of the reinforcing effect caused by the provision of both the unsheathed portion 10A and the adhesive uncoated portion can be held at minimum.

According to the method of producing the annular metal cord C3, the outer layer sheath made of the coating adhesive or rubber can be formed through similar steps to those in the first embodiment, and the annular metal cord C3 can be easily produced which is sturdy and is free from the problem that the metal filaments 6 constituting the second strand material 2, which serves as the outer layer portion 4, are loosened and unwound.

The annular metal cord C3 according to the third embodiment can be practiced in any of the various forms described above in connection with the first embodiment, and those modifications can also provide similar advantages to those obtained with the first embodiment.

### Fourth Embodiment

An annular metal cord according to a fourth embodiment will be described with reference to the drawing.

As shown in FIG. 21, an annular metal cord C4 according to the fourth embodiment includes an annular core portion 13 and an outer layer portion 14 which are similar to those in the annular metal cord C2 according to the second embodiment, but an outer layer sheath 10 is provided on an outer peripheral surface of the outer layer portion 14 in the form different from that in the second embodiment. In the annular metal cord C4, there are alternately formed a sheathed portion 10 in which the outer layer portion 14 is covered with an outer layer sheath and an unsheathed portion 10A in which the outer layer sheath is not formed and the outer layer portion 4 is exposed. The sheathed portion 10 having the outer layer sheath is formed by applying a coating adhesive which is similar to that used in the first to third embodiments, and hardening the applied coating adhesive. Alternatively, the sheathed portion 10 is formed of rubber which is similar to that used in the first to third embodiments.

Thus, in comparison with the annular metal cord C3 according to the third embodiment which is constituted by the first strand material and the second strand material, the annular metal cord C4 according to the fourth embodiment has a common structure except that the annular metal cord C4 is constituted by a single strand material.

A method of producing the annular metal cord C4 is also similar to the method of producing the annular metal cord C2 except for the difference in the forms of the sheathed portion 10 and the unsheathed portion 10A.

When the adhesive coated portion is provided on the annular core portion 13, the coating adhesive is applied to and hardened in predetermined locations on the outer peripheral surface of the annular core portion 13 such that the adhesive coated portion in which the coating adhesive is applied and hardened and the adhesive uncoated portion in which the coating adhesive is not applied are alternately formed.

When the annular metal cord C4 is used, for example, in the above-described endless metal belt B1 (see FIG. 13), the endless metal belt can be obtained which is rotated without meandering. The endless metal belt capable of rotating without meandering causes no wears resulting from contact with surrounding parts, and therefore it can maintain high performance over a long term.

According to the fourth embodiment also, since the joined portion 17 (see FIG. 19) between the winding start end 11a and the winding terminal end 11b of the strand material 11, which constitutes the outer layer portion 14, is covered, including the vicinity of the joined portion, with the outer layer sheath, the annular metal cord C4 can be made sturdy. In particular, the joined portion 17 between the winding start end 11a and the winding terminal end 11b of the strand material 11, which constitutes the outer layer portion 14, can be firmly reinforced. Further, such covering can eliminate the problem that the metal filaments 15 constituting the strand material 11 are loosened and unwound.

In addition, since the sheathed portion 10 coated with the outer layer sheath and the unsheathed portion 10A not coated with the outer layer sheath are alternately formed over the entire circumferential surface and the entire length of the outer layer portion 14, a lubricant can be smoothly permeated into the interior through the unsheathed portion 10A, thus suppressing a reduction of strength due to the friction between the annular core portion 13 and the outer layer portion 14, between adjacent parts of the strand material 11 constituting the outer layer portion 14, and between the metal filaments 15 constituting the strand material 11, as well as shortening of the useful life due to fatigue.

Moreover, since the sheathed portion 10 is formed to be longer than the unsheathed portion 10A such that the unsheathed portion 10A has the least necessary length for permeation of a lubricant into the interior and the sheathed portion 10 has a length as long as possible, the reinforcing effect can be increased and the useful life can be prolonged.

The unsheathed portion 10A is just required to be formed in at least one location in the circumferential direction of the outer layer portion 14. Even in such a case, a lubricant can be permeated into the interior through the unsheathed portion 10A. With such an arrangement, since an area of the unsheathed portion 10A is minimized, the reinforcing effect with the outer layer sheath 10 can be increased and the useful life can be prolonged.

Further, by alternately forming, on the outer peripheral surface of the annular core portion 13, the adhesive coated portion in which the coating adhesive is applied and hardened and the adhesive uncoated portion in which the coating adhesive is not applied, the annular core portion 13 can be reinforced in itself with the provision of the adhesive coated portion and the strength of the annular metal cord C4 can be increased. Also, the provision of the adhesive uncoated portion enables a lubricant to be smoothly permeated into the interior of the annular core portion 13 through the adhesive uncoated portion, thus suppressing a reduction of strength due to the friction between the metal filaments 15 constituting the strand material 11 which serves as the annular core portion 13, as well as shortening of the useful life due to fatigue.

Additionally, by shifting the position of the unsheathed portion 10A not coated with the outer layer sheath 10 and the position of the adhesive uncoated portion on the annular core portion 13 from each other in the circumferential direction, a reduction of the reinforcing effect caused by the provision of both the unsheathed portion 10A and the adhesive uncoated portion can be held at minimum.

According to the method of producing the annular metal cord C4, the outer layer sheath made of the coating adhesive or rubber can be formed through similar steps to those in the second embodiment, and the annular metal cord C4 can be easily produced which is sturdy and is free from the problem that the metal filaments 15 constituting the strand material 11, which forms the outer layer portion 14, are loosened and unwound.

The annular metal cord C4 according to the fourth embodiment can be practiced in any of the various forms described above in connection with the second embodiment, and those modifications can also provide similar advantages to those obtained with the second embodiment.

### INDUSTRIAL APPLICABILITY

While in the above-described embodiments the annular metal cord is applied to an endless metal belt for transmitting power in a speed reducer, the annular metal cord of the present invention can also be applied to endless metal belts for use in machines or apparatuses other than speed reducers. For example, the annular metal cord of the present invention is applicable to an endless metal belt for transmitting power between paper feed rollers in a printing machine such as a printer, an endless metal belt for performing straight driving of a uniaxial robot, an endless metal belt for performing driving of an X-Y table or driving of a three-dimensional carriage, and an endless metal belt for performing precision driving in optical equipment, inspectors or measuring units.

While the present invention has been fully described in connection with the specific embodiments, it is obvious to those skilled in the art that the present invention can be modified and changed in various ways without departing from the spirit and scope of the invention. This application is based on Japanese Patent Application (No. 2006-291728) filed Oct. 26, 2006, Japanese Patent Application (No. 2007-050573) filed Feb. 28, 2007, and Japanese Patent Application (No. 2007-148298) filed Jun. 4, 2007, which are incorporated herein by reference in their entirety.

1. An annular metal cord comprising an annular core portion formed in an annular shape, and an outer layer portion spirally wound around the annular core portion while running over an annular circumference thereof plural times and covering an outer peripheral surface of the annular core portion, each of the annular core portion and the outer layer portion being formed by a strand material which is formed by intertwisting a plurality of metal filaments,
wherein at least part of the outer layer portion is covered with an outer layer sheath made of a coating material having elasticity.

2. The annular metal cord according to claim 1, wherein a part of the outer layer portion including at least a joined portion between a winding start end and a winding terminal end of the outer layer portion is covered, including the vicinity of the joined portion, with the outer layer sheath.

3. The annular metal cord according to claim 1, wherein an unsheathed portion is formed in an annular outer-half peripheral surface of the outer layer sheath in at least one location.

4. The annular metal cord according to claim 1, wherein an unsheathed portion is annularly entirely formed in an annular outer-half peripheral surface of the outer layer sheath in at least one location in a circumferential direction of a cross section thereof.

5. The annular metal cord according to claim 1, wherein an annular outer-half peripheral surface of the outer layer sheath is annularly entirely formed as an unsheathed portion.

6. The annular metal cord according to claim 1, wherein an unsheathed portion is formed in an annular inner-half peripheral surface of the outer layer sheath in at least one location.

7. The annular metal cord according to claim 1, wherein a sheathed portion coated with the outer layer sheath and an unsheathed portion not coated with the outer layer sheath are alternately formed over an entire circumferential surface and an entire length of the outer layer portion.

8. The annular metal cord according to claim 1, wherein a sheathed portion is formed to be longer than an unsheathed portion.

9. The annular metal cord according to claim 1, wherein an unsheathed portion is formed in at least one location in an annular direction of the outer layer portion.

10. The annular metal cord according to claim 1, wherein an adhesive coated portion in which a coating adhesive is applied and hardened and an adhesive uncoated portion in which the coating adhesive is not applied are alternately formed on an outer peripheral surface of the annular core portion.

11. The annular metal cord according to claim 1, wherein an unsheathed portion in which the outer layer portion is not covered with the outer layer sheath and an adhesive uncoated portion in which the annular core portion is not covered with a coating adhesive are arranged at positions differing from each other in an annular direction.

12. The annular metal cord according to claim 1, wherein a coating adhesive has a hardness of 22-60 and an elongation of 110-500% as physical properties after hardening thereof.

13. (canceled)

14. An annular metal cord comprising an annular core portion formed in an annular shape, and an outer layer portion spirally wound around the annular core portion while running over an annular circumference thereof plural times and covering an outer peripheral surface of the annular core portion, each of the annular core portion and the outer layer portion being formed by a strand material which is formed by intertwisting a plurality of metal filaments,
wherein at least part of the outer layer portion is covered with an outer layer sheath made of a coating material having elasticity, and
wherein the outer layer sheath is made of rubber.

15. The annular metal cord according to claim 14, wherein the rubber forming the outer layer sheath is bonded to the outer layer portion by a metal-rubber adhesive for bonding the metal and the rubber to each other.

16. The annular metal cord according to claim 14, wherein the rubber forming the outer layer sheath is vulcanized at a vulcanization pressure of 8 MPa or lower.

17. An endless metal belt including the annular metal cord according to claim 1.

18. A method of producing the annular metal cord according to claim 1, the method comprising the steps of:
pasting a masking tape to a part of the annular metal cord where the outer layer sheath is not to be formed; and
applying a coating adhesive over an outer peripheral surface of the outer layer portion, and removing the masking tape after the applied coating adhesive has hardened.

19. A method of producing the annular metal cord according to claim 14, the method comprising the steps of:
pasting a masking tape to a part of the annular metal cord where the outer layer sheath is not to be formed;
pasting raw rubber over an outer peripheral surface of the outer layer portion; and
removing the masking tape after carrying out a pressurization and a vulcanization process.
